(19) United States
(12) Patent Application Publication
(10) Pub. No.: US 2017/0197144 A1
(43) Pub. Date: Jul. 13, 2017

(54) Mobile Computing Device

(71) Applicant: Shalong Maa, Arlington, TX (US)

(72) Inventor: Shalong Maa, Arlington, TX (US)

(21) Appl. No.: 14/999,059

(22) Filed: Mar. 25, 2016

Related U.S. Application Data
(63) Continuation-in-part of application No. 13/999,618, filed on Mar. 13, 2014.

(51) Int. Cl. A63F 13/35; G06T 13/40; G06F 3/041; H04M 1/02; A63F 13/24; A63F 13/537; H04M 1/725; G06T 13/80; G06F 3/0488

(52) U.S. Cl. CPC A63F 13/35; G06T 13/80; G06T 13/40; G06F 3/041; G06F 3/0488; A63F 13/24; A63F 13/537; H04M 1/72544; H04M 1/026; H04M 2250/22

(57) ABSTRACT

Disclosed herein is a mobile computing device (100) having a touchscreen display (10F), a back panel (10B1), and non-displaying lateral sides, wherein at least one of these lateral side (10V) is touch sensitive for receiving user inputs. The back panel includes a plurality of game-interaction buttons (151, 152, 153, 154, 161, 162, 163, and 164). During gameplays, the user will be able to feel the positions of but will not see these game-interaction buttons. For the purpose of allowing the user to easily get used to the feeling of positions of these game-interaction buttons, each of these buttons is situated or received at the bottom of a relatively small concave area on the back panel. These game-interaction buttons will be used to control the movement and actions of an avatar (120) within a virtual game environment (10Z) on the display.

### CROSS-REFERENCE TO RELATED APPLICATIONS

The present application is a continuation-in-part application and claims the benefit of U.S. patent application Ser. No. 13/999,618, filed Mar. 13, 2014, of which the complete disclosures are incorporated fully herein by reference.

### TECHNICAL FIELDS

An embodiment of the present invention pertains generally to hardware configuration, features, and structural arrangement of a mobile computing device, and particularly, to game-control related features and structural arrangement of a mobile computing device.

### BACKGROUND OF THE INVENTION

Prior art computer video game control systems employ handheld controllers which incorporate buttons and joysticks to enable a player or user to control an avatar (or other objects) depicted on a game display. In some cases, designs of these types of hand held controllers seeks to enable fine grained control of game play in robust, easy to use and intuitive manners. In these prior art sophisticated computer video game control systems, the handheld controllers are usually separate from the corresponding bodies of the computing devices. In case of using a mobile computing device as the computing and display components of the gaming device, the handheld controller is usually integrated with the gaming device. In such prior art mobile gaming system or device, the game-control buttons and joysticks of the game controller and the display of the mobile device are all situated on the front side of the device. Such prior art mobile gaming devices are always much thicker than the most often used mobile computing devices (such as smart phones) which are usually less than 1.0 cm thick; and thus the commonly used mobile computing devices usually do not have any game-control buttons and joysticks.

As it is well known, the very basic functionalities of a sophisticated gaming device shall include user-input or game-control means for making an avatar in a virtual environment on a game display move to the left, right, front, and back, for making the aviator look up and down, and for 360-degree rotation of the views of the virtual environment, etc. These avatar-control functionalities are usually realized through one or two analog sticks/nubs (or the like). Since the acceptable thinness of a tough-based mobile device, such as the smart phone or tablet computer, is usually about 1 cm or less, it's impractical to install a reliable analog stick/nub. Alternatively, said avatar-control functionalities may also be realized by using physical press buttons, which are traditionally installed on the front panel of the gaming device, and are designed to be operated by the user's two thumbs. But such an arrangement will require at about eight physical buttons, which will occupy about 3-4 inches of the device's front-panel space. However, even a large mobile computing device, such as a tablet computer, usually only has a front panel width of less than 10 inches.

One solution, according to the prior art, is to use the touch screen of the mobile computing device to provide simulated game-control buttons, which will substantially reduce the display area of the device both in the horizontal and in vertical direction of the screen. Moreover, most users prefer to have wide-screen (or landscape) display, i.e., the aspect ratio of the display area of the game is the same or similar to that of the full display, while playing a computer video game. Thus using simulated game-control buttons on the touch screen is not suitable. In addition, the prior art mobile computing devices only facilitate very limited touch-gesture input means.

This Background description and the Technical Fields description set forth above are provided to introduce a brief context for the Summary and Detailed Description that follow. They are not intended to be an aid in determining the scope of the claimed subject matter nor be viewed as limiting the claimed subject matter to implementations that solve any or all of the disadvantages or problems presented above.

### SUMMARY OF THE INVENTION

According to one aspect of the present invention, a plurality of game-control physical buttons (or the like) are provided at the rear side or rear panel (instead of at the front side) of a mobile computing device. During game playing, these game-control buttons shall be operated by the user's index or middle fingers (instead of by the thumbs), and the user or player will not see these game-control buttons. This is feasible because a user will only need a very limited amount of time to get used to the feeling of the positions of these game-control buttons at the rear side, which is similar to the user experience of typing on a keyboard without looking at the keyboard. In some preferred embodiments, each of these game-control buttons are situated at the bottom of a concave or bowl-shaped small area (or “cup”) on the rear side of the mobile computing device, such that at least a substantial portion of the game-control button is situated under the surface of the rear side. In this way, it is much less likely for the user to “accidently” touch an undesired button or to touch a wrong button (i.e., making input mistake) during game play. This is important because when a user is playing a sophisticated game, such as a competition game, he/she often needs to switch between different game-control buttons very quickly, and it usually takes a long time and lot of “efforts” to reach to a high level; and a single “mistake” could end the game, wasting the entire previous efforts.

An alternative embodiment of the present invention is to provide a mobile computing device with detachable analog nubs (or analog sticks) at the front side of the device. Since the analog nubs (or sticks) can be detached from the device, they will not increase the thickness of the mobile computing device when the user is not using the device to play computer video games.

The foregoing is intended to be merely a summary, and not to limit the scope of the present specification. The features of the present invention that are believed to be novel are set forth with particularity in the annexed claims. The invention, together with further objects and advantages thereof, may best be appreciated by reference to the following detailed description taken in conjunction with the drawings.

### BRIEF DESCRIPTION OF THE DRAWINGS

FIG. 1 is a functional block diagram of an exemplary mobile computing device architecture for implementing certain concepts of providing game-control buttons and certain methods related thereto of some embodiments of the present invention.

FIG. 2 is a schematic illustration of the front display of the mobile device of FIG. 1, showing an exemplary virtual environment in a computer video game.

FIGS. 3-10 are schematic illustrations of arrangements of game-control buttons at the rear side of the mobile computing device of FIG. 1 according to the present invention. FIG. 3 is for illustrating the general concept of putting game-control buttons at the rear side of the mobile computing device according to the present invention.

FIG. 4 is for illustrating an embodiment of the present invention in which the game-control buttons are situated above the surface of the rear side or back panel of the mobile computing device of FIG. 1. FIG. 5 is a side view of the mobile computing device of FIG. 4.

FIGS. 6-8 are for illustrating another embodiment of the present invention in which the game-control buttons are situated at the bottoms of relatively small concave areas, respectively, below the surface of the rear side or back panel of the mobile computing device. FIG. 7 is a cross-sectional view of the mobile computing device taken along a central line of FIG. 6; FIG. 8 is a cross-sectional view taken along a cross line of FIG. 6.

FIGS. 9 and 10 are for demonstrating alternative arrangements of game-control buttons according to some embodiment of the present invention; FIG. 10 is a cross-sectional view taken along a central line of FIG. 9.

FIGS. 11-17 are schematic representations of the front displays of the mobile computing device of FIG. 1 for demonstrating user input means associated with the touch sensitive lateral sides of the mobile computing device and for demonstrating the concepts and methods of combination hand gesture input according to another aspect of the present invention. FIG. 11 is for illustrating an exemplary conventional front-touch hand gesture input in connection with a photo album application on the mobile computing device.

FIG. 12 is for demonstrating an exemplary combination hand gesture input, in comparison with the conventional front-touch hand gesture input of FIG. 11, according to some embodiment of the present invention.

FIG. 13 is for demonstrating an exemplary side-touch hand gesture input according to some embodiment of the present invention.

FIG. 14 is for illustrating an exemplary conventional front-touch hand input in connection with a web browser application on the mobile computing device.

FIG. 15 is for demonstrating an exemplary combination hand input, in comparison with the conventional front-touch hand input of FIG. 14, according to some embodiment of the present invention.

FIG. 16 is for demonstrating an exemplary combination hand gesture input with a web browser application on the mobile computing device according to some embodiment of the present invention.

FIG. 17 is for demonstrating an exemplary side-touch hand gesture input with respect to the application of displaying and browsing through multi-windows on the mobile computing device according to some embodiment of the present invention.

FIGS. 18-21 are schematic representations of the front displays of the mobile computing devices and the associated user input methods for demonstrating the concepts and methods of two-screen mobile computing device according to yet another aspect of the present invention. FIGS. 18A and 18B are for demonstrating the concept of using the touchscreen of a mobile computing device as a touch pad for controlling a cursor on a secondary display device according to some embodiment of the present invention.

FIG. 19 is for demonstrating the concept of using the touchscreen of a mobile computing device as a touch pad for scrolling the display content on a secondary display device according to some embodiment of the present invention.

FIG. 20 is for demonstrating alternative methods of using the touchscreen of a mobile computing device as a touch pad for controlling the cursor and for scrolling the display content on a secondary display device, in comparison with those of FIGS. 18 and 19, according to some embodiment of the present invention.

FIG. 21 are for demonstrating the concept of virtual mouse and the methods of making the display content on the secondary display device either independent from, or connected with or attached to, the display content on the (primary) display of the mobile computing device in response to the user' hand gesture inputs or hand inputs or to the user's combination hand (gesture) inputs.

FIGS. 22-24 are schematic representations of the front displays of the mobile computing device of FIG. 1 for demonstrating the concept of calendar-based social network application of the present invention. FIG. 22 are for demonstrating the concept of how a user's calendar events can be viewed by one of his or her social friends; FIG. 23 are for demonstrating the concept of social authoring; and FIG. 24 are for demonstrating two more different ways for a user to allow his or her calendar events to be viewed by his/her social friends.

### DETAILED DESCRIPTION OF THE INVENTION

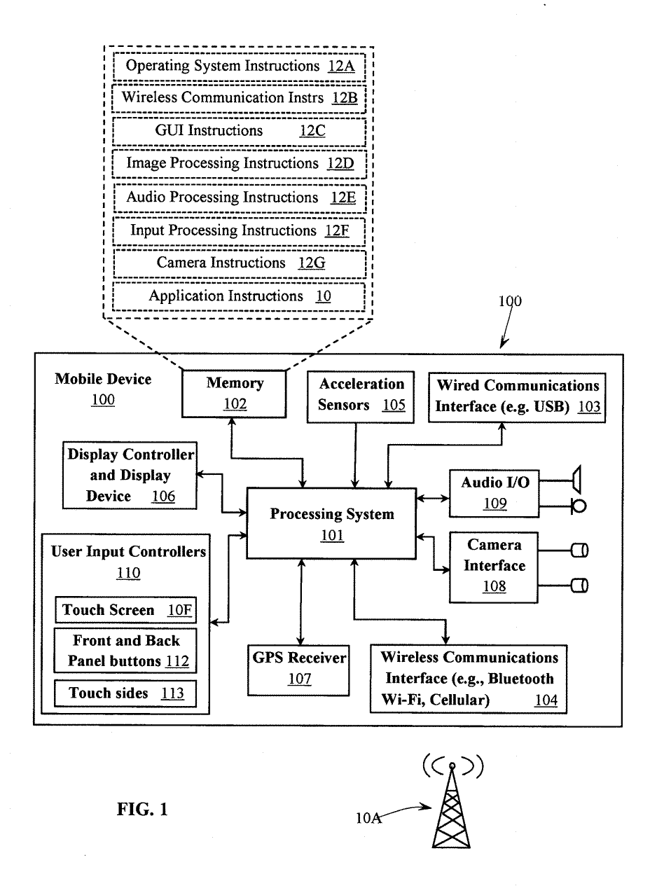

Referring to FIGS. 1-24, there are shown new and novel mobile computing device having physical game-control buttons and touch-sensitive lateral side frame of the present invention. While the present inventions are susceptible to embodiments in various forms, there is provided detailed description of the presently preferred embodiments, with the understanding that the present disclosure is to be regarded as exemplifications, and does not limit the invention to the specific embodiments illustrated and/or described. In many instances, detailed descriptions of well-known elements, electronic circuitry, or computer or network components, and computer program steps are omitted so as to not obscure the depiction of the invention with unnecessary details.

It shall also be understood that, in cases where the best mode is not particularly pointed out herein, the preferred embodiment described shall be regarded as the best mode; and that, in cases where best mode is alleged, it shall not be construed as having any bearing on or as contemplating the results of future research and development. The industrial exploitation of the present invention, such as the ways of making, using, and of the sales of the related software and hardware products, shall be obvious in view of the following detailed description.

Furthermore, the claimed subject matter may be implemented as a method, apparatus, or article of manufacture using standard programming and/or engineering techniques to produce software, firmware, hardware, or any combination thereof to control a computer to implement subject matter disclosed herein. The term “article of manufacture”, as used herein or in the annexed claims, is intended to encompass a computer program accessible from any computer-readable device, carrier, or media. Software or firmware to implement the techniques introduced herein may be stored on a “computer-readable (or machine-readable) storage medium” and may be executed by one or more general-purpose or special-purpose programmable microprocessors.

A “computer-readable (or machine-readable) medium”, as the term is used herein and in the annexed claims, includes any mechanism that can store information in a form accessible by a machine (a machine may be, for example, a computer, network device, cellular phone or mobile computing device, personal digital assistant (PDA), manufacturing tool, any device with one or more processors, etc.). By way of example, and not limitation, computer-readable storage media may include volatile and non-volatile, removable and non-removable media implemented in any method or technology for storage of information such as computer-readable instructions, data structures, program modules or other data. For example, a computer-readable or machine-readable or machine-accessible medium may include (but not limited to) recordable/non-recordable media, such as read-only memory (ROM), random access memory (RAM), EPROM (erasable programmable read only memory), EEPROM (electrically erasable programmable read only memory), magnetic storage devices (e.g., hard disk, floppy disk, magnetic strips, magnetic cassettes . . . ), optical storage media or optical disks (e.g., compact disk (CD), digital versatile disk (DVD), CD-ROM, HD-DVD, BLU-RAY . . . ), smart cards, and flash memory devices (e.g., card, stick, key drive . . . ) or other solid state memory technology.

Mobile Computing Device in General

Reference is now made to FIG. 1, which is a block diagram of exemplary architecture of a mobile computing device 100 for implementing certain concepts of arrangement of physical game-control buttons of some embodiments of the present invention. The mobile computing device 100 may be, for example, a smartphone, a tablet, a laptop, etc. As shown therein, the exemplary mobile computing device 100 includes a processing system 101, which may include one or more microprocessor(s) or a system on a chip of integrated circuit. The mobile computing device 100 also includes memory 102 for storing data and programs for execution by the processing system 101. The memory 102 may include volatile memory (e.g., high-speed random access memory (RAM) which acts as external cache memory), non-volatile memory (e.g., flash memory, read-only memory (ROM)), combination of volatile and non-volatile memory, and/or any other type(s) of memory. The memory 102 stores an operating system (OS) 12A. The OS 12A includes instructions for handling basic system services and for performing hardware-dependent tasks.

The memory 102 also includes: (b) wireless communication instructions 12B to facilitate wireless communication with other computing devices or with a computer network; (c) graphic user interface (or GUI) instructions 12C for facilitating GUI processing; (d) image processing instructions 12D to facilitate image-related functions and processing tasks; (e) audio processing instructions 12E for facilitating audio-related processing and functioning; (f) input processing instructions 12F for facilitating input-related (such as input from the touchscreen, or the touch-sensitive lateral sides, or from the game-control buttons of the mobile device 100 described below) processing and functioning; (g) camera instructions 12G for facilitating camera-related processing and functioning; and (h) application instructions 10 that are related to the mobile device Apps. Evidently, the memory 102 may include other instructions to facilitate the respective functioning of the mobile computing device 100.

The exemplary mobile computing device 100 of FIG. 1 also includes: (A) an audio input/out subsystem 109 for coupling a microphone and/or a speaker to the processing system 101; (B) a display controller 106 for coupling a display device to the processing system 101, so as to provide a digital visual user interface for the user. This digital visual device interface may include a graphical user interface; (C) one or more wireless communication interfaces 104 for communication with other mobile devices or with other computer systems or networks. For examples, a wireless communications interface 104 may be a WLAN transceivers (i.e., receiver and transmitter), an infrared transceiver, a Bluetooth transceiver, and/or a cellular telephony transceiver, etc.; and these transceivers of some embodiments are implemented to operate over one or more communication means or communication networks, such, for examples, as GSM or other cellular network, NFC, Bluetooth, RFID, Wi-Fi, and/or any other suitable wireless communications networks. Reference number 10A in FIG. 1 represents generally a mobile communication network.

The exemplary mobile computing device 100 of FIG. 1 also includes: (D) user-input controllers 110 for coupling one or more user-input devices to the processing system 101. These input devices may include physical buttons 112 at the front or back panel of the mobile device 100 (as described below in connection with some embodiment of the present invention), a front touch-sensitive screen 10F, and touch-sensitive lateral sides 113 (as described below in connection with some embodiment of the present invention) of the mobile device 100; (E) one or more wired power and communication interface 103 (such as a USB port or the likes) for facilitating wired communication with another computing devices or for connection to a power source or the like; (F) a camera interface 108 that is coupled with one or more optical sensors to facilitates camera functions, such as image or video data capturing, etc.; (G-H) an acceleration sensor 105 (such as an accelerometer) and a satellite navigation system receiver 107 (such as a Global Positioning System (GPS) receiver) that are coupled to the processing system 101.

It is understood that, while the components illustrated in FIG. 1 are shown as separate components, one of ordinary skill in the art will recognize that two or more components may be integrated into one or more integrated circuits. In addition, two or more components may be coupled together by one or more communication buses or signal lines. Also, while many of the functions have been described as being performed by one component, one of ordinary skill in the art will realize that any function described herein with respect to FIG. 1 may be split into two or more integrated circuits. Moreover, mobile device 100 of FIG. 1 may be one or be a combination of a number of mobile wireless communications devices, such as a cellular telephone, mobile media device, mobile Wi-Fi or WiMax communications device, satellite radio, voice-over-IP (VOIP) mobile communications device, mobile digital media player, etc.

Game-Control (Physical) Buttons on Back Panel of Mobile Computing Device.

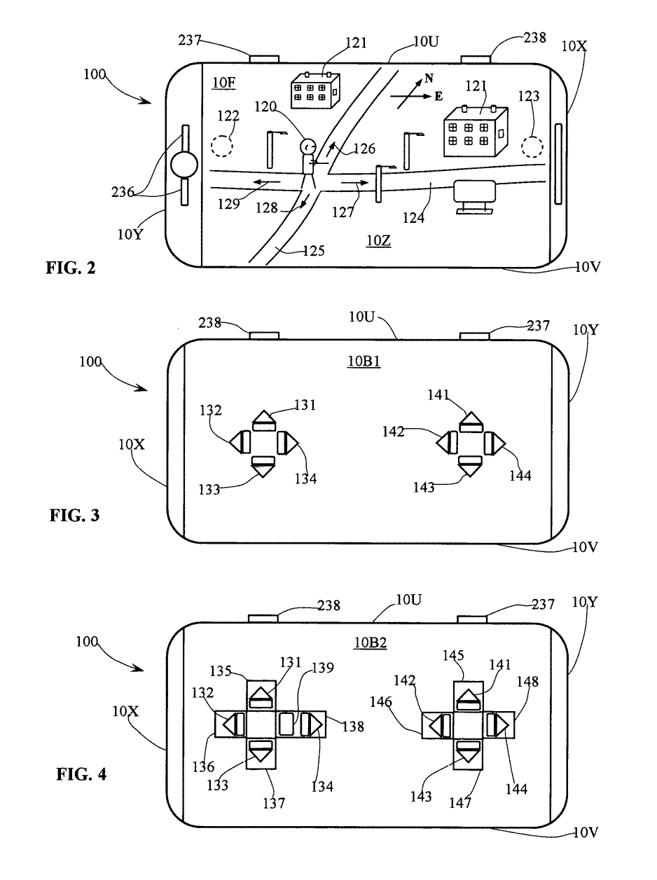

Reference is now made to FIGS. 2 and 3 in conjunction with FIG. 1. As shown therein, the external structure of the body of the mobile computing device 100 comprises a touchscreen display 10F at the front side, a back panel 10B1 at the rear side, and four non-displaying lateral sides 10U, 10V, 10X, and 10Y. These four lateral sides extend between the front side 10F and the rear side 10B1. It is preferred that a substantial portion of the front side comprises the touchscreen electronic display 10F of the mobile computing device 100. In the example of FIG. 2, the front side also includes a plurality of physical buttons 236 for facilitating user input, and the lateral side 10U also includes two physical buttons 237 and 238.

FIG. 2 is a schematic representation of the front side display 10F of the mobile computing device 100, showing an exemplary virtual environment 10Z of a computer video game. FIG. 3 is a schematic representation of the back panel 10B1 of the mobile computing device 100 for illustrating the general concept of putting game-control buttons at the rear side of the mobile computing device according to the present invention. As shown in the figures, according to a preferred embodiment of the present invention, the body of the mobile computing device 100, or any portion thereof, is not configured to articulate relative to another structural portion. And thus it is a non-hinged, non-articulating body that structurally supports substantially the entire mobile computing device. The front side 10F, the rear side 10B1, and the four non-displaying lateral sides 10U, 10V, 10X, and 10Y are stationary relative to one another.

The exemplary computer video game represented by the virtual environment 10Z on the display 10F in FIG. 2 may execute locally on the mobile computing device 100, or it be hosted remotely by a video game service provider, or use a combination of local and remote execution in some cases. The game 10Z may also be one in which multiple other players can participate. It will be appreciated that multi-player gaming is often typically supported or facilitated by a remote server computer, and there is no limit as to the locations of the players. Alternatively, multi-player gaming may also be done locally where all the players can see one another. For example, all the players (or mobile computing device users) may be playing the same game in a room.

The exemplary virtual gaming environment 10Z of FIG. 2 includes virtual buildings 121, virtual roads 125 and 124, and other types of virtual objects or elements for simulating a city. In general, the virtual (gaming) environment 10Z may comprise many virtual objects or elements. In the current example, an avatar 120 is situated at the intersection between the two virtual roads 125 and 124. The virtual buildings 121, virtual roads 125 and 124 may be deemed examples of “other virtual objects and elements” (other than the avatar 120) within the virtual environment 10Z. So the player (or mobile computing device user) may cause the avatar 120 to move in directions 126, 127, 128, or 129. The user (not shown) may also want to control the speed of such avatar motion. The user (not shown) may also cause the avatar 120 to interact with other virtual objects in the virtual environment 10Z, such as picking up or catching or hitting a virtual item, unlocking a door or the likes, etc., and to perform quests combat, and the like, and other actions, etc. The user may also want to cause the virtual gaming environment 10Z to rotate relative to the avatar 120, and to control the speed of such rotation. The avatar 120 may be deemed one of many virtual objects within the virtual environment 10Z; and therefore, the avatar 120 may be regarded as the “primary virtual object”, as such term may be used herein and in the annexed claim.

As it is well known in the art, when the user causes the position of the avatar 120 to change in the virtual environment 10Z, or causes the avatar 120 to rotate in the virtual environment 10Z, the display view 10F of the mobile computing device 100 shall change accordingly for simulating such Avatar 120's changes in position or rotation relative to the virtual environment 10Z; and usually it is this relative changes in position or rotation between the avatar 120 and the virtual environment 10Z that is to be simulated and displayed on the game display view 10F. In case of 3D gaming, the display view 10F sometimes may be understood as the view of a game camera mounted either on top of (or a little behind the top of) the head of the avatar 120, or mounted somewhere close to the head of the avatar 120, such that the display view 10F is for simulating whatever is seen by the avatar 120 in the virtual environment 10Z. In case of 2D gaming, the display view 10F sometimes may be understood as the view of a game camera mounted to the side of the avatar 120 or far above the avatar 120. It is also understood that the game designer may make the game display view 10F simulate any angular views in any part of the virtual environment 10Z, and there is no limitation as to which part of the virtual environment 10Z and which angular view thereof is to be simulated on the game display view 10F.

The user generally controls the position, motion, and rotation of the avatar 120 relative to the virtual environment 10Z by entering user input, such as on a joystick or controller. But, the prior art mobile computing devices do not provide physical game-interaction joystick or controller. So it is not feasible for the user of any prior art mobile computing device to play hi-end computer video games. According to the present invention, as shown in the FIG. 3 example, a plurality of game-control (user input) buttons 131, 132, 133, 134, 141, 142, 143, and 144 are provided on the back panel 10B1 of mobile computing device 100. During game playing, these game-control buttons shall be operated by the user's index or middle fingers (instead of by the thumbs), and the mobile device user will not see these game-control buttons. This will allow the user to play hi-end computer games without increasing the physical thickness of the device. An alternative method is to provide the mobile computing device 100 with detachable analog nubs (or analog sticks) at the front side of the device. Since the analog nubs (or sticks) can be detached from the device, they will not increase the physical thickness of the device.

The game designer shall decide how to let users use these game-control buttons to interact with the game. In one example, the eight game-control or user-input buttons 131, 132, 133, 134, 141, 142, 143, and 144 on the back panel 10B1 in FIG. 3 may be used for providing 8-dimensional avatar-movement control. As it is well known in the art and as shown in FIG. 2, most of the high-end 3D computer video games involve multi-dimension controls of avatar 120 (or the like) in virtual gaming environment 10Z. Such avatar controls can be regarded as comprising eight dimensions, including the avatar 120 moving (i) forward (in direction 127), (ii) backward (in direction 129), (iii) to the left (in direction 126), and (iv) to the right (in direction 128); and also the avatar 120 (v) looking up, (vi) looking down; (vii) rotating or spinning clockwise, and (viii) rotating or spinning counterclockwise relative to the virtual gaming environment 10Z.

So in this example in connection with FIGS. 2 and 3, these 8-dimension avatar controls are provided by the eight physical game-control buttons at the back panel 10B1 of the mobile computing device 100. In particular, (i) the button 142 may be used for moving the avatar 120 forward in direction 127; (ii) the button 144 may be used for moving the avatar 120 backward in direction 129, (iii) the button 143 may be used for moving the avatar 120 to the right in direction 128, (iv) the button 141 may be used for moving the avatar 120 to the left in direction 126; (v) the button 131 may be used for making the avatar 120 look upward, (vi) the button 133 may be used for making the avatar 120 look downward, (vii) the button 134 may be used for making the avatar 120 rotate toward its left (or the avatar 120 rotates counterclockwise relative to the virtual gaming environment 10Z), and (viii) the button 132 may be used for making the avatar 120 rotate toward its right (or the avatar 120 rotates clockwise relative to the virtual gaming environment 10Z). Again, all these avatar motions and rotations are relative to the virtual gaming environment 10Z, which shall be simulated accordingly on game display view 10F.

The game-control buttons 141, 142, 143, and 144 are to be operated by the index or middle finger of the user's left hand; And the game-control buttons 131, 132, 133, and 134 are to be operated by the index or middle finger of the user's right hand. In case where the user wants the avatar 120 to move towards a front-left direction, for example, she may press the buttons 134 and 142 together at the same time. So these eight buttons on the back panel 10B1 of the mobile computing device 100 can provide full control of an avatar (or the like) in a high-end 3D computer video game. Certainly, the game designers can assign these buttons to different avatar-control functions. For example, when the avatar 120 in the game is (or is inside) a helicopter, the buttons 131 and 133 can be assigned to be used for ascending and descending respectively, etc. It is understood that, (A) when these game-interaction or game-control or user-input buttons are not pressed or touched by the user, the “input” or user instruction received from these buttons are defined herein as “Null input” or “Null input instruction” (which is the default input), as such term may be used herein and in the annexed claims. Similar to the conventional gaming devices, when the processor of the mobile computing device 100 receives null input instruction from any of these game-control or user-input buttons, it will usually stop or reduce the speed of moving or rotation of the avatar 120 within the virtual environment 10Z. So for examples, (i) when the user starts pressing the button 142, the avatar 120 will start moving forward in direction 127; (ii) if the user keeps holding down or repeatedly presses the button 142, the avatar will move faster and faster; (iii) if user releases the button 142, the avatar will either stop immediately or slow down and stop slowly. Alternatively, if the user switches to pressing the button 144 from button 142, and continue pressing the button 144, the avatar will first slow down, then it will stop, and thereafter, it will move in the opposite direction 129. It is also understood that, (B) often the game designer may design the game in such a way that, the user will need to press more than one buttons at the same time. For example, if the user wants the avatar to move and to change the moving direction simultaneously, the user may need to press the forward button 142 and the rotation button 132 simultaneously. When more than one user-input or game-interaction buttons (including any of the virtual buttons, such as virtual buttons 122 and 123, on the front display 10F, see below) are pressed by the user, the resultant input received from these buttons is called “combination input” or “combination input instruction”, as such term may be used herein and in the annexed claims. Such combination inputs are for instructing the avatar to perform a “complex action” within the virtual environment 10Z, such as term may be used herein and in the annexed claim. Examples of such avatar's “complex action” include (but not limited to): (a) moving forward and changing the moving direction at the same time; (b) moving forward and jumping at the same time, (c) moving forward while lowering the avatar's body position, (d) kicking, punching, and/or striking another virtual object or element in a complex manner, etc.

More game-interaction or game-control buttons may be simulated on the front touchscreen display 10F. In the example of FIG. 2, in addition to displaying the primary display content (i.e., the virtual gaming environment 10Z) of the computer video game, the front screen 10F also provides two simulated (or virtual) buttons 122 and 123 near its two sides 10Y and 10X respectively. These simulated virtual buttons 122 and 123 may be operated by the user's two thumbs for various game interaction purposes. For example, the simulated virtual buttons 122 and 123 be used for causing the avatar 120 to perform a main strike action (or the likes). As it is well known in the art, many of the computer video games provide the avatar with at least one (or more) form of strike action. Examples of such avatar strike actions are: pulling the trigger of a weapon, kicking or hitting a ball, catching a ball, hitting a bad guy, etc.

In order to provide more avatar-control means, the four non-displaying lateral sides 10X, 10Y, 10U, and 10V of the mobile device 100 can also be made touch sensitive. In this way, the front display 10F can provide button indicators at its edges for indicating which segment of the touch-sensitive sides is to be used for a particular form of avatar control function. It is understood that, physical buttons usually give the user more comfortable feeling of “pressing a button” during gameplay. And such a type of comfortable feeling during interaction with the game cannot be replaced by a simulated button on the touch-sensitive screen 10F or by a segment of a touch-sensitive lateral side. So the physical buttons 237 and 238 on the lateral side 10U, and the physical buttons 236 at the front side of the mobile computing device 100 may be used for game interaction or game control.

As well known in the art, many categories of video computer games involve substantial amount of competition (or sports) elements or the like. Examples of such competition/sports elements in a game are: the user trying to (i) make the avatar 120 quickly move to the left at the highest possible speed in order to hit a tennis ball, (ii) make the avatar take a small step to the right in order to throw or kick a ball to the right teammate, and (iii) have the avatar kicking the soccer ball at an finite upward direction in order to pass through the defense players, etc. When a game include substantial amount of such type of competition elements, usually double-clicking a button is the maximum the user wants to do, meaning that triple clicking (or more) or holding the button would be deemed too slow or non-intuitive, and would thus substantially reduce the entertainment value of the game. Therefore, in some embodiment of the present invention, more game-control buttons may be provided at the back panel 10B2 of the mobile device 100. In the example of FIG. 4, comparing with the example of FIG. 3, an additional avatar left-rotating button 139 is added such that, for example, the button 134 may be used for making the avatar 120 rotate toward its left very fast, and the additional game-control button 139 may be used for making the avatar 120 rotate toward its left slowly. Alternatively, the game-control buttons 132, 134, and 139 may be used for causing the avatar 120 to move forward and backward relative to the virtual gaming environment 10Z; and the game-control buttons 142 and 144 may be used for causing the avatar 120 to rotate relative to the virtual gaming environment 10Z. Therefore, there is no limit as to the number of game-control buttons on the back panel of the mobile computing device 100. Since the back panel 10B2 cannot be seen by the user during the game play, it is necessary to carefully arrange the positions of these game-control buttons to make it intuitive for operations by the user's index or middle fingers.

The arrangement of the game-control buttons on the back panel of the mobile computing device 100 described above shall give the game designers much more flexibility in providing rich game-interaction features. For examples, the video computer game 10Z can be designed to including the following features: (i) if the user wants to move avatar 120 forward slowly, she can single click the button 142; (ii) if the user want to move avatar 120 forward very fast, she can double click or hold down the button 142, and (iii) if the user want to move the avatar 120 quickly to the left, she can double click the button 141, etc.

FIG. 5 is a side view, toward the lateral side 10V, of the mobile computing device 100 of FIG. 4. The relative positions of the lateral sides 10X, 10Y, 10U, and 10V of the device in FIGS. 4 and 5 are the same as that of FIGS. 2 and 3. In the example of FIGS. 4 and 5, each game control button is surrounded by a border. In particular, (i) the game-control button 142 is surrounded by a border 146; (ii) the game-control button 144 is surrounded by a border 148; (iii) the game-control button 141 is surrounded by a border 145; (iv) the game-control button 143 is surrounded by a border 147; (v) the game-control button 132 is surrounded by a border 136; (vi) the game-control buttons 134 and 139 are surrounded by a border 138; (vii) the game-control button 131 is surrounded by a border 135; and (viii) game-control button 133 is surrounded by a border 137.

The purpose of providing these button-surrounding borders 146, 148, 145, 147, 136, 138, 135, and 137 is to let the user rest her/his operating fingers at the best positions when such operating fingers are not operating the game-control buttons. When the user “rests” one of her fingers on these borders, she can easily feel where such finger is located relative to the game-control buttons. Again, the user cannot see the back panel 10B2 during the game play. Alternatively, some individual buttons on the back panel 10B2 within a border can be replace by a piece of continuous touch pad or the like. For examples, the two game-control buttons 134 and 139 within the border 138 may be replaced by a piece of continuous touch pad within the border 138. Also alternatively, the game-control buttons on the back panel 10B1 or 10B2 of the mobile device 100 described above in association with FIGS. 3 and 4 can be replaced by a pair of detachable analog sticks (or analog nubs) at the front panel of the device 100.

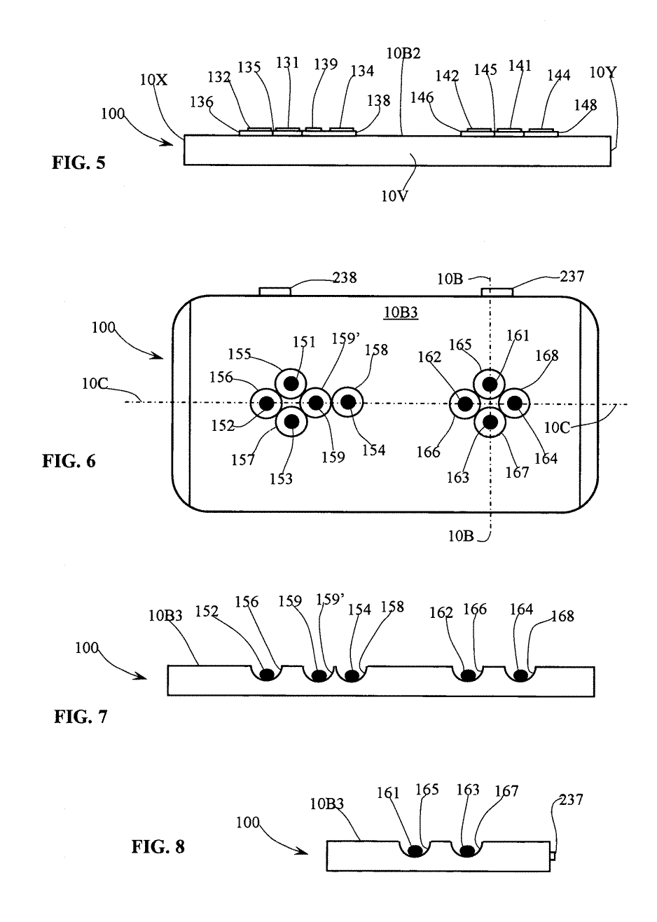

Reference is now made to FIGS. 6-8, which illustrate another (or preferred) embodiment of arrangement of game-control buttons at the back panel 10B3 of the mobile computing device 100 according to the present invention. FIG. 6 is a top view of the exemplary back panel 10B3. FIG. 7 is a cross-sectional view of the mobile computing device 100 taken along a central line 10C-10C of FIG. 6; FIG. 8 is a cross-sectional view taken along a cross line 10B-10B of FIG. 6. As shown therein, the back panel 10B3 of the mobile computing device 100 includes nine game-control buttons arranged into two groups. The first group, which is to be operated by right-hand finger(s) of a user, include game-control buttons: 151, 152, 153, 154, and 159. The second group, which is to be operated by left-hand finger(s) of a user, include game-control buttons: 161, 162, 163, and 164. It is understood that, the back panel 10B3 may include more than nine game-control buttons, or it may include less than nine game-control buttons.

As shown in FIGS. 6-8, each of the nine game-control buttons is situated at the bottom of a relatively small concave area (or bowl). These relatively small concave area are embedded under the surface of the back panel 10B3. For examples: (i) the buttons 151, 152, 153, 154, and 159 are situated at or near the bottom of concave areas 155, 156, 157, 158, and 159′ respectively; and (ii) buttons: 161, 162, 163, and 164 are situated at or near the bottom of concave areas 165, 166, 167, and 168 respectively. One of the purposes of such an arrangement is to make it much easier to for the user to feel the position of each game-control button without actually touching the button, because as soon as the user touch the edge of the concave area of a game-control button, he/she shall be able to feel the position of the button without actually touching it. This is important because, again, the user will not be able to see these game-control buttons, which are installed at the back panel 10B3 of the mobile computing device 100, during game playing.

The concave shapes of the relatively small concave areas 156, 159′, 158, 166, and 168 can be readily seen from the cross-section view of FIG. 7 in conjunction with FIG. 6. The concave shapes of the relatively small concave areas 165 and 167 can be readily seen from the cross-section view of FIG. 8 in conjunction with FIG. 6. Each of the concave areas is deemed relatively small compared with (or relative to) the size of the back panel 10B3. The size of each of the relatively small concave areas shall be appropriate for accommodating (diameter of) an average human fingertip.

As used herein and in the annexed claims, the term “concave area” means an exterior surface area on the back panel 10B3 of the mobile computing device 100 that curves inward like (for examples) the interior or inside of a bowl, or like the interior or inside of a hollow sphere, such that when a game-control button is situated or received at or near the bottom of such concave area, at least a portion of the button will be below the surface of the back panel 10B3 (or below the portion of the surface of the back panel 10B3 surrounding the edge of the concave area). And it should also be understood that, there is no limit as to the exact geometry shape of such concave area, and it may not be precisely same as the interior of a hollow sphere. The only physical characteristics of such concave area is, such an area curves inward, such that the game-control button situated at or near the bottom thereof shall be substantially or entirely below the surface of the back panel 10B3 (or below the edge or boundary of the concave area). Moreover, there is no limit as to the geometry shape of the edge or boundary of each of the relatively small concave areas. One of the purposes of such arrangement of making a game-control button situated at or near the bottom of a relatively small concave area is, it would be much less likely for the mobile device user to press the wrong (or undesired) button when playing a mobile game. This is because, during game play, as soon as a user has touched the edge of a relatively small concave area, he or she will usually have a feeling of whether it is a right or wrong button (after some practices). But the user will not make any “mistake” until he or she actually touches the game-control button at the bottom of the bowl. If a substantial portion of any of the game-control buttons is situated above the surface of the back panel 10B3, then it would be more likely for the mobile device user to press the wrong (or undesired) button when playing a mobile game. So the embodiment of FIGS. 6-8 will make it much easier for the mobile computing device user to get used to using these game-control buttons which the user will not be able to see, when playing a mobile game.

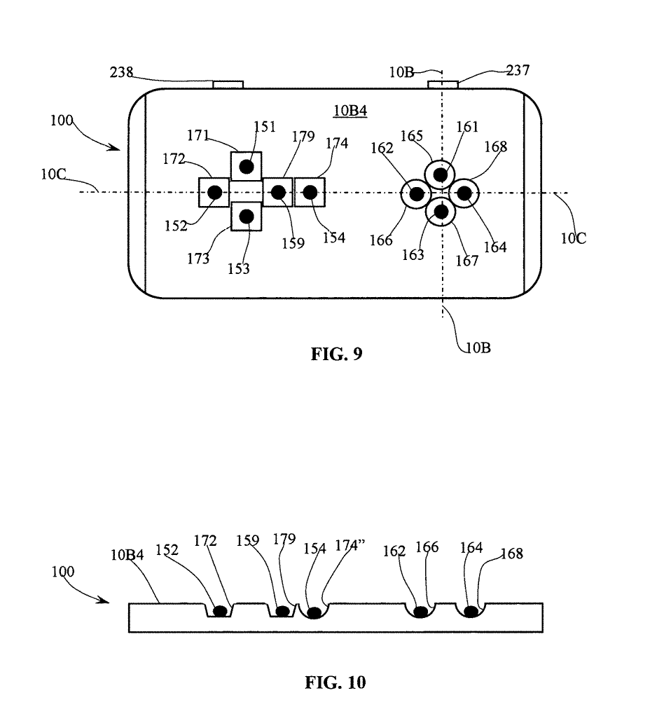

FIGS. 9 and 10 are provided for demonstrating an alternative arrangement of the relatively small concave area associated with each of the game-control buttons according to some embodiment of the present invention. FIG. 9 is a top view of the exemplary back panel 10B4 of the mobile computing device 100. FIG. 10 is a cross-sectional view taken along a central line 10C-10C of the mobile computing device of FIG. 9. As shown therein, the back panel 10B4 also includes two groups of game-control buttons. The first group, which is to be operated by right-hand finger(s) of a user, include game-control buttons 151, 152, 153, 154, and 159; the second group, which is to be operated by left-hand finger(s) of a user, include game-control buttons: 161, 162, 163, and 164 (same as FIGS. 6-8). As shown therein, on the back panel 10B4, the physical characteristics of the four left-hand game-control buttons 161, 162, 163, and 164, including the four respective relatively small concave areas 165, 166, 167, and 168 are same or similar to those on the back panel 10B3 of FIGS. 6-8.

As shown in FIG. 9, (i) the five right-hand game-control buttons 151, 152, 153, 154, and 159 are situated, respectively, at or near the bottoms of five relatively small concave areas 171, 172, 173, 174, and 179; and (ii) the boundaries or edges of these five relatively small concave areas are not circular; there are more like square or rectangular shapes. Therefore, again, there is no limit as to the geometric shape of edge or boundary of any of the relatively small concave areas for receiving the respective game-control buttons on the back panel of the mobile computing device 100. Moreover, the concave surfaces of these relatively small concave areas for receiving the respective game-control buttons may also have various geometric shapes. As shown in FIG. 10, (i) the relatively small concave areas 172 and 179 (for receiving the game-control buttons 152 and 159 respectively) have relatively flat bottoms; whereas (ii) the cross-section surfaces of the relatively small concave areas 174/174″, 166, and 168 (for receiving the game-control buttons 154, 162 and 164 respectively) are more like the interior or inside of a hollow sphere.

Touch-Sensitive Lateral Sides of Mobile Computing Device

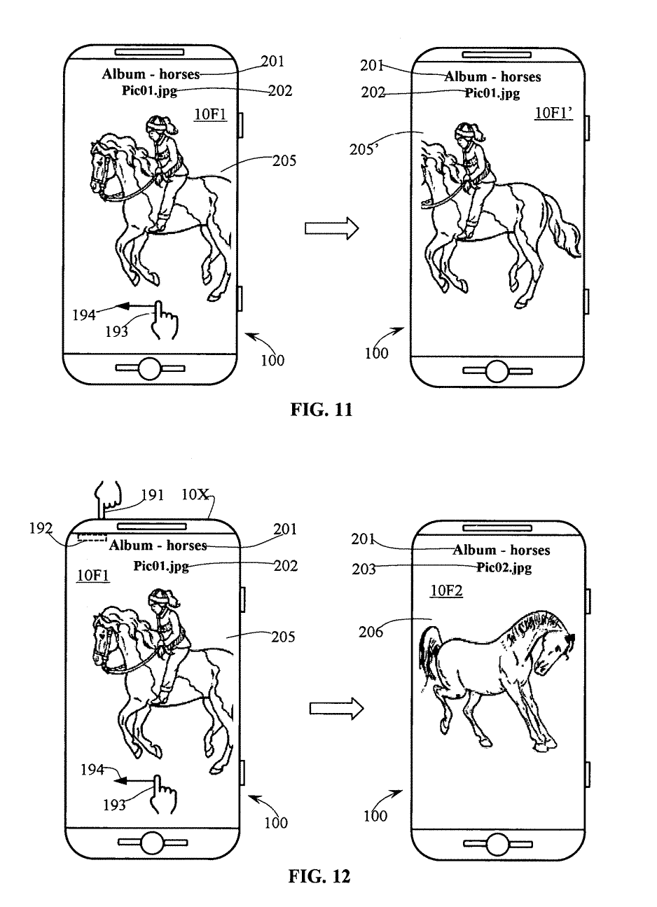

Again, the mobile computing device 100 of the present invention includes four lateral sides 10X, 10Y, 10U, or 10V; any of these four lateral sides may be made touch sensitive, which may be used for user input in addition to using the front touchscreen. Moreover, the touch-sensitive lateral sides may be used in combination with using the front touchscreen for user input, so that more user input means maybe provided. The examples of using the touch-sensitive lateral sides and the front touchscreen of the mobile computing device 100 for user input according to the present invention as described as follows in connection with FIGS. 11-17.

FIG. 11 includes two exemplary display views of the mobile computing device 100, and is for demonstrating the effect of a conventional front-touch hand gesture input. In this FIG. 1, in response to a front-touch hand gesture input performed by a user's hand 193 on the front touchscreen 10F1, the display view on the mobile computing device 100 will be changed from display view 10F1 to display view 10F1′. It is understood that the same reference numbers 10F1 (and 10F1′) are used for representing the display view and the front touchscreen of the mobile computing device 100. Same below. As shown therein, the mobile App executed on the mobile computing device 100 is a photo album app 201. The first display view 10F1 shows one of the photo 205 within the album 201. The photo 205 has a file name 202 (“Pic01.jpg”). The front-touch hand gesture input is performed by a user's hand 193 on the front touchscreen 10F1, which is indicated by the arrow 194. After such front-touch hand gesture input, the display content on the mobile computing device 100 will be changed from display view 10F1 to display view 10F1′. The display views 10F1 and 10F1′ are similar to one another, and they both show the same photo file 202, except that the display view 10F1 does not show the entire rear portion 205 of the photo 202, whereas the display view 10F1′ does not show the entire front portion 205′ of the photo 202. So the result of the conventional front-touch hand gesture input of FIG. 11 is for causing the mobile computing device to display different portion of the same display content. And in this case, the display content is the same photo 205 (and 205′) having the same file name 202.

As used herein and in the annexed claim, (I) the term “front-touch hand gesture input” means user input through the front touchscreen of the mobile computing device, in which the user slides her finger(s) across (or against) the surface of the touchscreen; the user may use one or more than one of her fingers to slide across the surface of the touchscreen 10F1; the sliding may be fast or slow; and the force of the user's finger(s) against the touchscreen 10F1 during such sliding may also vary; (II) the term “display view” (such as display views 10F, 10F1, 10F1′, 10F2, 10F3, 10F4, 10F4″, 10F5, 10F5′, 10F6, 10F7, 10F8, 10F9, 10F10, 10F11, 10F12, 10FA, 10FB, 10FC, 10BD, 30F1, 30F2, 30F3, 30F4, 30F5, 30F6, 30F7, 30F8, 30F9, 40F1, 40F2, 40F3, 40F4, 50F1, 50F2, 50F3, 50F4, 50F5 in the drawings) means whatever elements, objects, texts, and images that are displayed on the display device and are visible to the user, which is not the same as display content; (III) the term “display content” (such, for examples, as the photo image 205 (205′), the web pages 99A, 99B, 281, 281′ and 282 in the drawings) (other examples may include a web-based map, a large office document, a large web page, a large photo image, etc.) means an integrated content for display and associated with an App, an application, a component of the Operating System, or a web link, etc.; In some cases, only a portion of a display content maybe displayed; and (IV) the term “scrolling” means causing different portion of a display content to be displayed on the display of the computing device. So the portion of a display content that is displayed on the display device is the “display view”.

FIG. 12 includes two exemplary display views of the mobile computing device 100, and is for demonstrating a combination hand gesture input according to one embodiment of the present invention. In FIG. 12, the mobile App executed on the mobile computing device 100 is the same as that of FIG. 11, which is photo album app 201, and the first display view 10F1 is also the same as that of FIG. 11, showing the one of the photo 205 within the album 201; and the photo 205 has a file name 202 (“Pic01.jpg”). In FIG. 12, the user input is a combination hand gesture input, and as a result of such combination hand gesture input, the display content of the mobile computing device 100 shall change from display view 10F1 to display view 10F2.

In FIG. 12, the combination hand gesture input involves the user's two hands and also involves the front touchscreen 10F1 and the touch-sensitive lateral side 10X of the mobile computing device 100. (i) the user input by the user's 1^{st} hand 193 is the same as the front-touch hand gesture input of FIG. 11, which is indicated by the arrow 194; (ii) the user input by the user's 2^{nd} hand 191 is by using the user's finger to touch or hold against a predefined position on the touch-sensitive lateral side 10X, and such user input by the user's 2^{nd} hand 191 is represented by the term “side-touch hand input”, as such term may be used herein and in the annexed claim. This side-touch hand input by the user's 2^{nd} hand 191 is indicated by a virtual indicator 192 on the display view 10F1 of FIG. 12.

So in FIG. 12, the user input is a combination hand gesture input that includes a front-touch hand gesture input by the user's 1^{st} hand 193 and a side-touch hand input by the user's 2^{nd} hand 191. Usually the user may start holding the predefined position on the lateral side 10X (the side-touch hand input) slightly before front-touch hand gesture input. And in response to such a combination hand gesture input, the display content on the mobile computing device 100 shall change from display view 10F1 to display view 10F2. Display view 10F2 shows a second photo 206, having a file name 203 (“Pic02.jpg”), within the photo album 201. So the result of such combination hand gesture input of FIG. 12 is to change the display content of the mobile computing device 100 from the first photo 205 to the second photo 206 within the same App 201. It is understood that the function of the combination hand gesture input described above may not be limited to the example of FIG. 12. For examples, it may be used for causing the display of the mobile computing device 100 to be changed or switched between any two different display views of the same or different mobile Apps, or for causing the display of the mobile computing device 100 to change or switch between various forms of arrangement of multiple windows, to change or switch between various forms of arrangement of application tools or display contents within a mobile App, or to change or switch between various forms of arrangement operating system tools or display contents, etc.

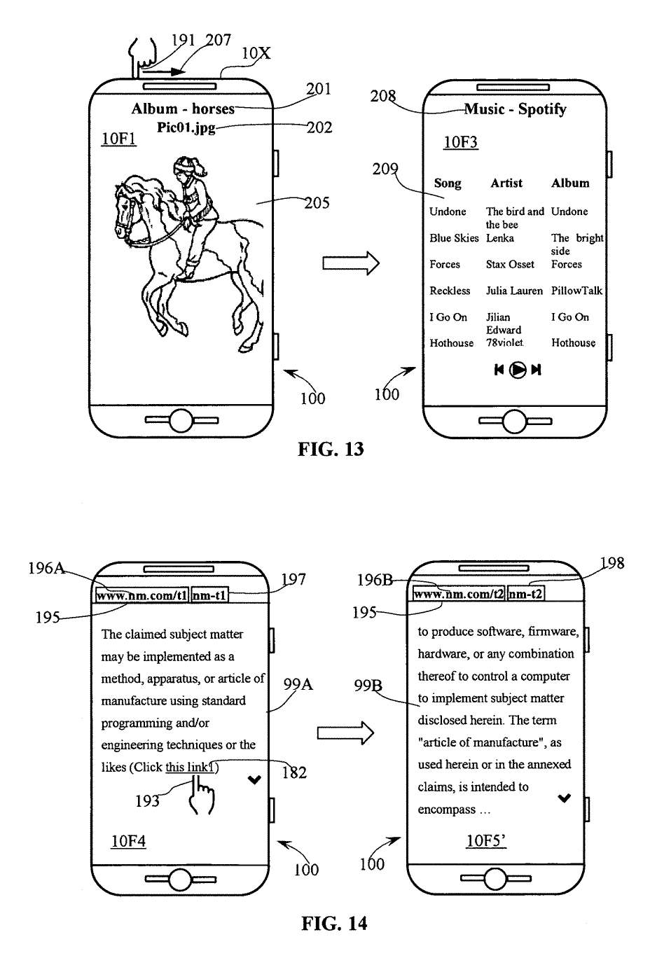

FIG. 13 includes two exemplary display views of the mobile computing device 100, and is for demonstrating a side-touch hand gesture input according to one embodiment of the present invention. The example of FIG. 13 involves two mobile Apps being executed by the mobile computing device 100: (i) the first mobile App executed on the mobile computing device 100 is the same as that of FIG. 11, which is photo album app 201, and the first display view 10F1 is also the same as that of FIG. 11, showing one of the photo 205 within the album 201; and the photo 205 has a file name 202 (“Pic01.jpg”); (ii) the second mobile App executed on the mobile computing device 100 is a music playing App 208 (“Music—Spotify”), as is shown on the second display view 10F3. In FIG. 13, the user input is a side-touch hand gesture input, and as a result of such side-touch hand gesture input, the display of the mobile computing device shall change from display view 10F1 to display view 10F3.

As used herein and in the annexed claim, the term “side-touch hand gesture input” means user input through a touch-sensitive lateral side of the mobile computing device 100, in which the user slides her finger(s) across (or against) the surface of the touch-sensitive lateral side; the user may use one, or more than one, of her fingers to slide across the surface of the touch-sensitive lateral side; the sliding may be fast or slow; and the force of the user's finger(s) against the touch-sensitive lateral side during such sliding may also vary. In the example of FIG. 13, the side-touch hand gesture input is indicated by the arrow 207, involves one of the user's hands 191, and is performed on the touch-sensitive lateral side 10X of the mobile computing device 100.

As shown in FIG. 13, as a result of the side-touch hand gesture input indicated by the arrow 207, the display of the mobile computing device 100 will change from the display view 10F1 of the mobile App 201 (“Album—horses”) to the display view 10F3 of the mobile App 208 (“Music—Spotify”). So the function of the side-touch hand gesture input in the FIG. 13 example is to change the display of the mobile computing device from a display view of a first mobile App to a display view of a second mobile App. It is understood that the function of the side-touch hand gesture input described above may not be limited to the example of FIG. 13. For examples, it may be used for causing the display of the mobile computing device 100 to be changed or switched between any two different display views of the same or different mobile Apps, or for causing the display of the mobile computing device 100 to change or switch between various forms of arrangement of multiple windows, to change or switch between various forms of arrangement of application tools or display contents within a mobile App, or to change or switch between various forms of arrangement operating system tools or display contents, etc.

FIG. 14 includes two exemplary display views of the mobile computing device 100, and is for demonstrating a conventional front-touch hand input. The two display views 10F4 and 10F5′ in the example of FIG. 14 involve the same mobile App being executed by the mobile computing device 100, i.e., a web browser having a web address box 195. The first display view 10F4 is the display content of a web page 99A, as indicated by the web address 196A (“www.nm.com/t1”) within the box 195 and also indicated by the browser tab 197; The display content on the second display view 10F5′ is a second web page 99B, as indicated by the web address 196B within the box 195 and also indicated by the browser tab 198. On the display view 10F4, there is a web link 182 which is a link to the web address 196B. So when the link 182 is clicked on by the user's hand 193, the web page 99B having the web address 196B will be displayed, as is shown on the second display view 10F5′. Such a user input of clicking a link 182 (or a button) on the touchscreen 10F4 is represented by the term “front-touch hand input”, as such term may be used herein and in the annexed claim. And the function of such front-touch hand input in the FIG. 14 example is to cause the display of the mobile computing device 100 to change from one web page 99A to another linked web page 99B. It is understood that, in this FIG. 14 example, and also in the examples described below, the same reference number 195 may be used to represent both the web browser App and the web address box of the web browser.

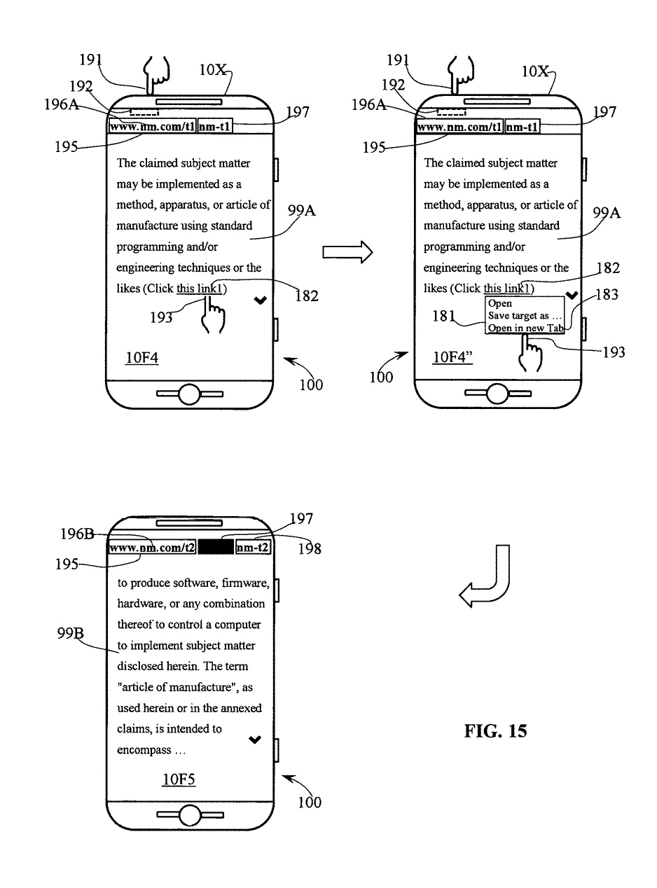

FIG. 15 includes three exemplary display views of the mobile computing device 100, and is for demonstrating a combination hand input according to some embodiment of the present invention. The three display views 10F4, 10F4″ and 10F5 in the example of FIG. 15 also involve the same mobile App being executed by the mobile computing device 100, i.e., a web browser having a web address box 195 (again, the same reference number 195 may be used to represent both the web browser App and the web address box of the web browser). The first display view 10F4 of FIG. 15 is the same as the first display view 10F4 of FIG. 14, which is a web page 99A, as indicated by the web address 196A (“www.nm.com/t1”) within the box 195 and also indicated by the web browser tab 197. The web page 99A includes a web link 182. The second display view 10F4″ of FIG. 15 is the same as the first display view 10F4, i.e., the web page 99A having a web address 196A, except that there is dropdown menu 181. The third display view 10F5 of FIG. 15 is the display content of a second web page 99B, as indicated by the web address 196B within the box 195 and also indicated by a second web browser tab 198. On the 3^{rd} display view 10F5, the web browser App includes two tabs 197 and 198, and the displayed web page 99B is associated with the second browser tab 198.

On the first display view 10F4, the web link 182 is a link to the web address 196B of the third display view 10F5. So when the link 182 is clicked on by the user in a conventional manner, the web page 99B having the web address 196B will be displayed. But in this example of FIG. 15, the user input is a combination hand input involving the user's two hands 191 and 193. A finger of the user's 1^{st} hand 191 is holding or pressing against a predefined segment on the touch-sensitive lateral side 10X; and such pressing against the touch-sensitive lateral side 10X by the user's first hand finger 191 is indicated by an indicator 192 on the display view 10F4. While the user's first hand finger 191 is pressing against the touch-sensitive lateral side 10X, as indicated by the indicator 192, the user's second hand finger 193 will click on the link 182 on the display view 10F4. As a result of such combination hand input involving the user's two hands 191 and 193, a dropdown menu 181, which is a context menu associated with the link 182, will be displayed, as is shown on the second display view 10F4″.

The context menu 181 provides the user with three options for interacting with the link 182, including the third option 183 which is for opening the web page 98B associated with the link 182 in a new web browser tab 198 on the same web browser App. So by clicking on this option link 183 (as indicated by the user finger 193 associated with the second display view 10F4″), the display of the mobile device 100 will be changed to the third display view 10F5. Again, this third display view 10F5 is the display content of web page 99B, as indicated by the web address 196B within the box 195 and also indicated by a new browser tab 198 on the web browser having a web address box 195; and again, the web address 196B is associated with the link 182 on the first and second display views 10F4 and 10F4″. As it is well known in the art, if the user just click on the link 182 in a conventional manner (i.e., without the combination hand input and without the context menu), then by default, the web page 99B associated with the link 182 will be displayed on the first browser tab 197, without creating the new browser tab 198 by the web browser.

Therefore, the combination hand input facilitated by the touch-sensitive lateral side 10X shall give the user more options as to how to interact with a web link. It is understood that the function of the combination hand input described above is not limited to the example of FIG. 15. Such web link, or link, 182 may be regarded generally as a “display element”, as such term may be used herein and in the annexed claims. So the combination hand input may be used for displaying context menu associated with any display element, such, for examples, as a button, a link to a file or a web address or an application, a shortcut, a folder, or a filename, or the likes, or for displaying context menu associated with any display section on a computing device display. Such combination hand input can be used to simulate the “right click” function of a conventional computer (PC) mouse; such “right click” function is well known in the art.

It is understood that, in the examples of FIGS. 11-17, it is assumed that the user shall hold the mobile computer device 100 as indicated in the drawings (i.e., portrait view). Therefore, in normal situation, the top lateral side 10X shall not be touch by the user's hand. So the touch-sensitive lateral side 10X can be used for user input as described herein.

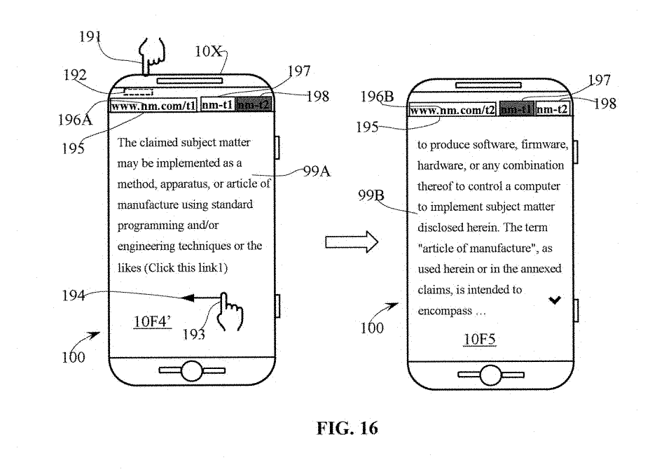

FIG. 16 includes two exemplary display views of the mobile computing device 100, and is for demonstrating another example of combination hand gesture input according to one embodiment of the present invention. The two display views 10F4′ and 10F5 in the example of FIG. 16 also involve the same mobile App being executed by the mobile computing device 100, i.e., a web browser having a web address box 195 (again, the same reference number 195 may be used to represent both the web browser App and the web address box of the web browser); and in both cases, there are two web browser tabs 197 and 198 opened. A web page 99A associated with a web address 196A (“www.nm.com/t1”) and the first browser tab 197 is displayed on the first display view 10F4′; A web page 99B associated with a web address 196B (“www.nm.com/t2”) and the second browser tab 198 is displayed on the second display view 10F5. The display of the mobile computing device 100 shall change from the first display view 10F4′ to the second display view 10F5 in response to a combination hand gesture input. Again, the same reference number 195 may be used to represent both the web browser App and the web address box of the web browser herein.

In FIG. 16, the combination hand gesture input is same or similar to the user input of FIG. 12; it involves the user's two hand fingers 191 and 193, and also involves the front touchscreen 10F4′ and the touch-sensitive lateral side 10X of the mobile computing device 100. (i) the user input by the user's 1^{st} hand 193 is the same as the front-touch hand gesture input of FIG. 11, which is indicated by the arrow 194; (ii) the user input by the user's 2^{nd} hand 191 is by using the user's finger to touch or hold against a predefined position on the touch-sensitive lateral side 10X, and such user input by the user's 2^{nd} hand 191 is represented by the term “side-touch hand input”, as such term may be used herein and in the annexed claim. This side-touch hand input by the user's 2^{nd} hand 191 is indicated by a virtual indicator 192 on the display view 10F4′ in FIG. 16. Usually the user may start holding the predefined position on the lateral side 10X slightly before front-touch hand gesture input.

So in FIG. 16, the user input is a combination hand gesture input that includes a front-touch hand gesture input by the user's 1^{st} hand 193 and a side-touch hand input by the user's 2^{nd} hand 191. And in response to such a combination hand gesture input, the display on the mobile computing device 100 shall change from the first display view 10F4′ to the second display view 10F5. So in this example of FIG. 16, the function of the combination hand gesture input is to allow the user to browse through the display contents of different tabs opened on a web browser. Again, the function of the combination hand gesture input is not limited to this example of FIG. 16. The web browser may have two or more than two tabs.

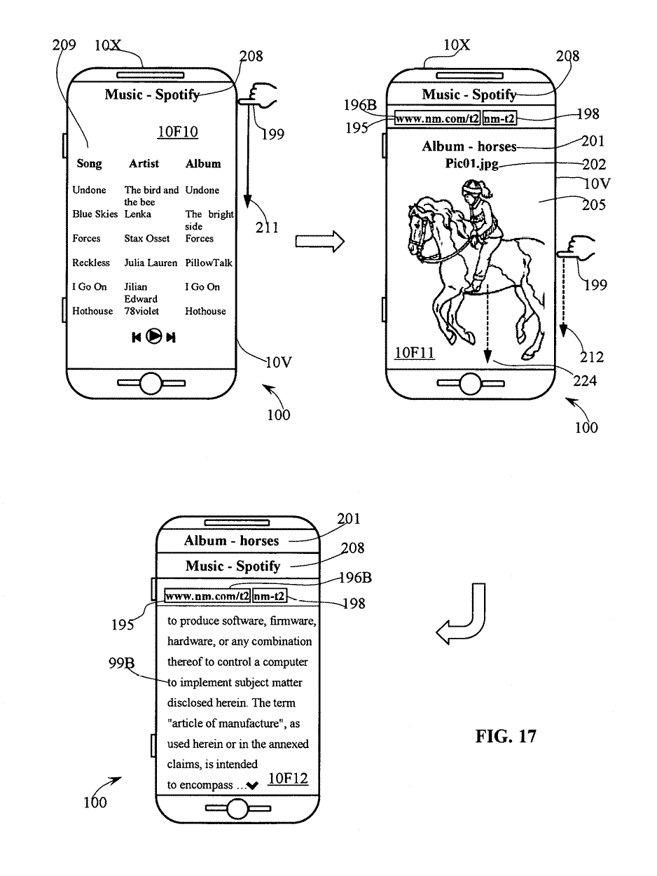

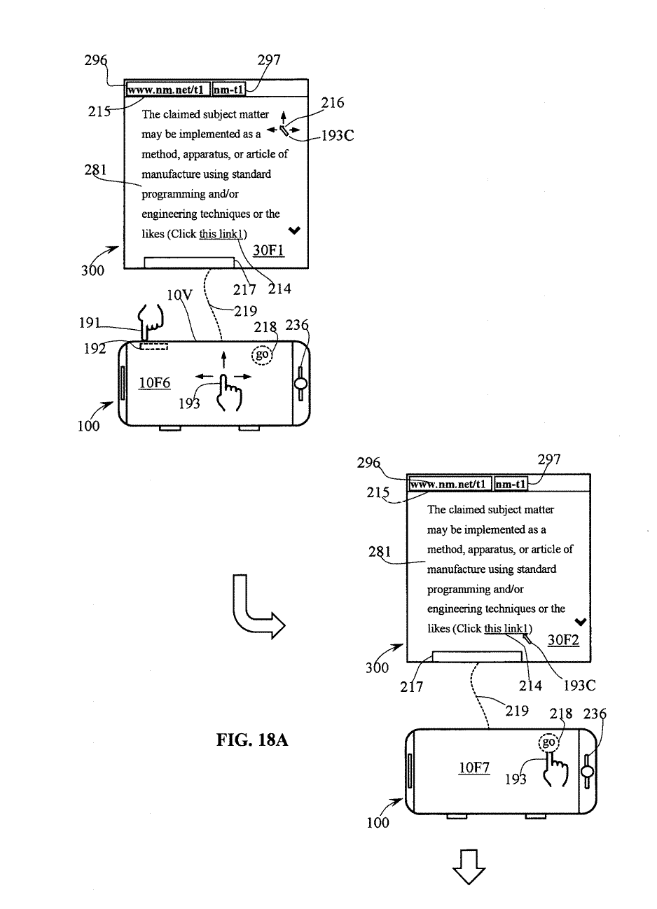

FIG. 17 includes three exemplary display views, 10F10, 10F11, and 10F12 of the mobile computing device 100, and is for demonstrating another example of the function of side-touch hand gesture input according to one embodiment of the present invention. The example of FIG. 17 involves three mobile Apps being executed by the mobile computing device 100. (i) the first mobile App being executed is a music playing App 208 (“Music—Spotify”) which has a display content 209, and is shown on the first display view 10F10. (ii) The second mobile App being executed is a photo album app 201 (“Album—horses”), and the related display content is a photo 205, which has a file name 202 (“Pic01.jpg”), within the album 201, as is shown by a majority portion of the second display view 10F11 (not including the displays of the other two Apps 208 and 195 at the top portion). (iii) The third mobile App being executed is a web browser App having a web address box 195 and a browser tab 198, and the related display content is a web page 99B which has a web address 196B (within the web address box 195), as is shown by a majority portion of the third display view 10F12 (not including the display of other two Apps 208 and 201 at the top portion). Again, the same reference number 195 may be used to represent both the web browser App and the web address box of the web browser herein.

In FIG. 17, the user input is a side-touch hand gesture input performed by a user hand 199, which is similar to the user input of the FIG. 13 example described above, except that the side-touch hand gesture input of FIG. 17 example is performed on the longer touch-sensitive lateral side 10V of the mobile computing device 100 (instead of on the top lateral side 10X). Such side-touch hand gesture input against the longer touch-sensitive lateral side 10V is indicated by the arrow 211 (next to the first display view 10F10). And as a result of such side-touch hand gesture input indicated by the arrow 211, the display of the mobile computing device 100 shall change from the first display view 10F10 to the second display view 10F11.

Again, the second display view 10F11 displays a photo 205 within a photo album app 201 (“Album—horses”). In addition, at the top section of the second display view 10F11, the top title portions of all other mobile Apps being currently executed by the mobile computing device 100, including the top title portions of the music playing App 208 (“Music—Spotify”) and the web browser App 195 (having a web address box 195, a browser tab 198, and an web address 196B), are also displayed on the second display view 10F11. Again, the first display view 10F10 entirely displays a music playing App 208 (“Music—Spotify”) without displaying the top title portion of any other mobile Apps being executed. And again, in the example of FIG. 17, the result of the side-touch hand gesture input indicated by the arrow 211 is to change the display of the mobile computing device from the display view 10F10 to display view 10F11.

Therefore, it is readily seen that the function of the side-touch hand gesture input indicated by the arrow 211 is to cause the display of the mobile computing device 100 to change from the display mode of fully displaying the first App 208 to a “multi-window display mode” as indicated by the display view 10F11 in FIG. 7 example. As shown in the figure, under such multi-window display mode 10F11, (i) a substantial portion of the display content 205 of the second mobile App 201 is displayed; and (ii) at the top portion of the display view 10F11, the top title sections (or at least a portion thereof) of all other active mobile Apps, including the Apps 195 and 208, are also displayed. So it shall appears to the user that, as a result of the side-touch hand gesture input indicated by the arrow 211, the first App 208 is “rotated” to the back under the multi-window display mode 10F11, and the next (or second) App 201 is “rotated” to the front. Under the multi-window display mode 10F11, if the user want full display of any of the Apps, he or she can just click on the displayed portion of the App.

Under the display view 10F11, if the user continues the side-touch hand gesture input, as indicated by the arrow 212 (or repeat the side-touch hand gesture input indicated by the arrow 211 next to the display view 10F10), or if the user does the front-touch hand gesture input indicated by the arrow 224, then the display of the mobile computing device 100 will change from display view 10F11 to the third display view 10F12. Display view 10F12 is also a multi-window display mode. Under such multi-window display mode 10F12, (i) a substantial portion of the display content 99B of the third mobile App 195 is displayed; and (ii) at the top portion of the display view 10F12, the top title section (or at least a portion thereof) of every other active mobile App, including that of the Apps 201 and 208, are also displayed. So it shall appears to the user that, as a result of the continuing side-touch hand gesture input indicated by the arrow 212, or the front-touch hand gesture input indicated by the arrow 224, the second App 201 is rotated to the back under the multi-window display mode 10F12, and the next (or third) App 195 is “rotated” to the front, while the display remain in the multi-window display mode.

The multi-window display mode represented by display views 10F11 and 10F12 shall give the user an overview or outline of (A) how many Apps are currently being executed by the mobile computing device, their relative positions (i.e., displaying sequence relative to one another), and (B) the title or top section of each App. It is understood that the arrangement of displays of Apps on the multi-window display mode is not limited to the example of FIG. 17. For example, in case of display view 10F11, (i) the area of display of the App 201 at the front may be smaller, and the areas of displays of the other two Apps may be larger, (ii) areas of displays of all the Apps may be substantially the same; or (iii) when there are many Apps being executed by the mobile computing device 100, the display view 10F11 may not include all the Apps, etc. One of the purposes of providing such multi-window display mode is to allow the user to browse through the display contents of all mobile Apps being executed by the mobile computing device 100.

Using Mobile Computing Device as a Touchpad

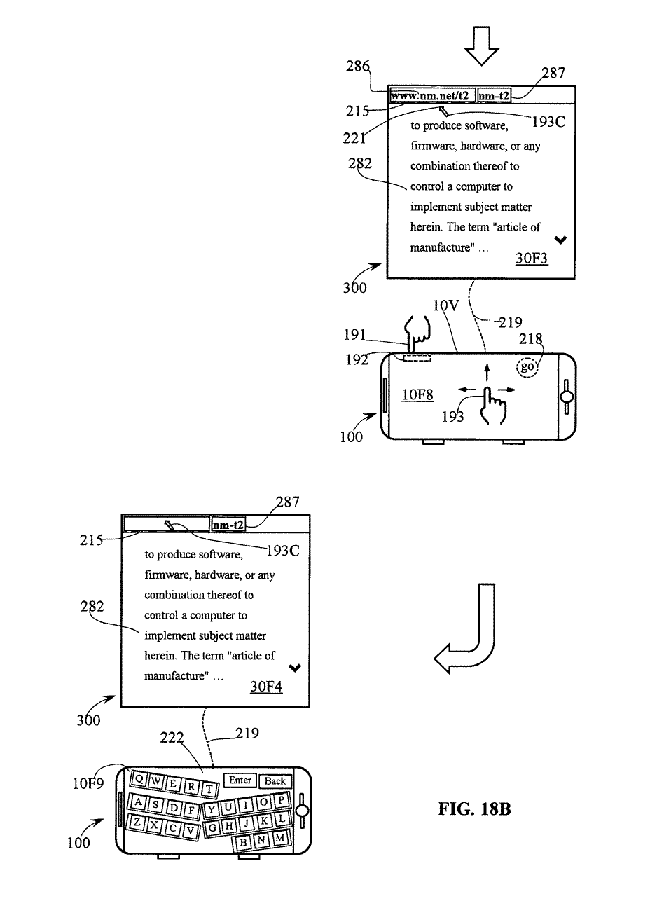

FIGS. 18A and 18B are for demonstrating another embodiment of user input of the present invention, in which the front touchscreen of the mobile computing device 100 is used as a touch pad by the user for controlling a cursor 193C on display view of a secondary display device 300. In FIGS. 18A and 18B, the display views 30F1, 30F2, 30F3, and 30F4 of the secondary display device 300 are associated, respectively, with the (primary) display views 10F6, 10F7, 10F8, and 10F9 of the mobile computing device 100. Providing the secondary display device 300 is particularly useful if it is much larger than the display of the mobile computing device 100, so that the mobile device user can use the system to do more complex tasks such as working on productivity software applications including spreadsheet (e.g., MS Excel), word processor (e.g., WordPerfect), etc., or working on graphical drafting or image processing related software applications (e.g., CAD). The secondary display device 300 and the mobile computing device 100 are connected with one another via a connection 219, which may be either a wired or wireless connection (e.g., USB, wireless USB, Bluetooth, or other forms of PAN (personal area network) or WPAN (wireless personal area network)).

In the example FIGS. 18A and 18B, it is assumed that, (i) the secondary display device 300 is only a display device for displaying (or enlarging) a display view of the mobile computing device 100, and it may not have any processing power for processing any application; (ii) the secondary display device 300 also may not have any function of receiving user input (for example, its screen may not be a touchscreen), so that it can be made as thin and light as possible (e.g., OLED display); and (iii) the secondary display device 300 may be substantially larger than the display area of the mobile computing device 100; and thus it's unnecessary to make the display of the mobile computing device 100 include any display content of any Apps.

In FIGS. 18A and 18B, the display views of the secondary display device 300 pertains to the display of a web browser application 215 being executed by the mobile computing device 100. Again, the same reference number 215 may be used to represent both the web browser App and the web address box of the web browser herein. The display views 30F1 and 30F2 pertain to a first web page 281, as indicated by the browser tab 297 and by the web address 296 (“www.nm.net/t1”) within the web address box 215; The display views 30F3 and 30F4 pertain to a second web page 282, as indicated by the browser tab 287 and by the web address 286 (“www.nm.net/t2”) within the web address box 215. On each of these four display views, there is a conventional cursor 193C that is controlled by the user input on the touchscreen of the mobile computing device 100. In particular, the user shall use the touchscreen of the mobile computing device 100 as a touchpad for the purpose of causing the cursor 193C to move to various positions on the display views of the secondary display device 300, and for clicking on any buttons or links thereon, which is similar to or the same as the functions of the touchpad of a laptop computer.

In the example of the display view 30F1 of the secondary display device 300 in FIG. 18A, a finger of the user's 1^{st} hand 191 is pressing against a predefined position on the touch-sensitive lateral side 10V of the mobile computing device 100, and at the same time, a finger of the user's 2^{nd} hand 193 is moving across the surface of the touchscreen 10F6 of device 100 for the purpose of moving the position of the cursor 193C on the display view 30F1 of the secondary display device 300. And consequently, the display of the secondary device 300 is first changed from display view 30F1 to display view 30F2. As shown on the 2^{nd} display view 30F2, the position of the cursor 193C has been moved from the original upper right position 216 (indicated on the 1^{st} display view 30F1) to the position of a web link 214. Thereafter, the user shall click on a virtual “go” button 218 to activate (or click) the link 214. Alternatively, the user can simply tap on the touchscreen 10F7, or press a physical “go” button 236 on the front panel of the mobile computing device 100, to click the link 214, and the result thereof is the 3^{rd} display view 30F3 of the secondary display device 300. The link 214 on the display views 30F1 and 30F2 is a link to a web address 286 of a second web page 282 shown on the 3^{rd} display view 30F3.

(I) The foregoing user inputs by the user's two hands 191 and 193 that are conducted, respectively, on the touch-sensitive lateral side 10V and on the front touchscreen 10F6 of the mobile computing device 100, for the purpose of moving the cursor 193C on the display view 30F1 of the secondary display device 300, using the touchscreen 10F6 as a touchpad, is represented by the term “combination touchpad input”, as such term may be used herein and in the annexed claims. (II) In some embodiment, the control of movement of the cursor 193C on the display view 30F1 of secondary display device 300 may be done without the side-touch hand input from the lateral side 10V (by the hand 191), in which case the movement of the cursor 193C may be controlled by moving a finger of the user's hand 193 across (against) the surface of the touchscreen 10F6 of the mobile computing device 100, which is the same as using the touchpad of a conventional laptop computer for cursor-movement control. And such a input from the touch screen 10F6 of the mobile computing device 100 by the user's single hand 193 (without using the hand 191 on the lateral side 10V) for the purpose of moving the cursor 193C on the display view 30F1 of the secondary display device 300, using the touchscreen 10F6 as a touchpad, is represented by the term “front touchpad input”, as such term may be used herein and in the annexed claims.

As shown in FIG. 18B, on the 3^{rd} display view 30F3, a second web page 282 is shown on the same web browser 215, and has a web address 286 within the web address box 215. After the second web page 282 is displayed on the display view 30F3 of the secondary display device 300, the user will, on the touchscreen 10F8 and on the touch-sensitive lateral side 10V of the mobile computing device 100, perform the aforementioned combination touchpad input, which is for the purpose of moving the cursor 193C towards the web address box 215. On the 3^{rd} display view 30F3, the cursor 193C has been moved to a position 221 that is close to the web address box 215 of the web browser. After the cursor 193C has been moved to the web address box 215 on the display of the secondary display device 300, as is shown on the display view 30F4, the user will tap the touchscreen 10F8 or click on a virtual “go” button 218 on the display 10F8 of the mobile computing device 100, which will bring up a virtual keyboard 222 on the display of the mobile computing device 100, as is shown on the display view 10F9. The virtual keyboard 222 shall allow the user to type in a new web address into the web address box 215. As shown therein, the virtual keys on the virtual keyboard 222 are arranged to maximum the size of each key, and thus the keys are not aligned to form three straight rows.

Thus, the descriptions above in connection with FIGS. 18A and 18B demonstrate the method and system of providing a mobile computing device 100 with a much larger secondary display device 300, and how to use the touchscreen of the mobile computing device 100 (i) as a touchpad for controlling a cursor 193C on the secondary display device 300, which is similar to the function of touchpad on a laptop computer, and (ii) as a virtual keyboard for typing. The virtual keyboard 222 shall be brought up whenever a text field (such, for examples, as a text box or the likes, or the body of a word-processing application, etc.) is clicked on by the cursor 193C. As it is well known, in order to allow the user to fully interact with all display elements or display contents on the secondary display device 300, in addition to the method of control of movement of the cursor 193C and the virtual keyboard 222 set forth above, another display interaction needed is scrolling, which is described in detailed below.

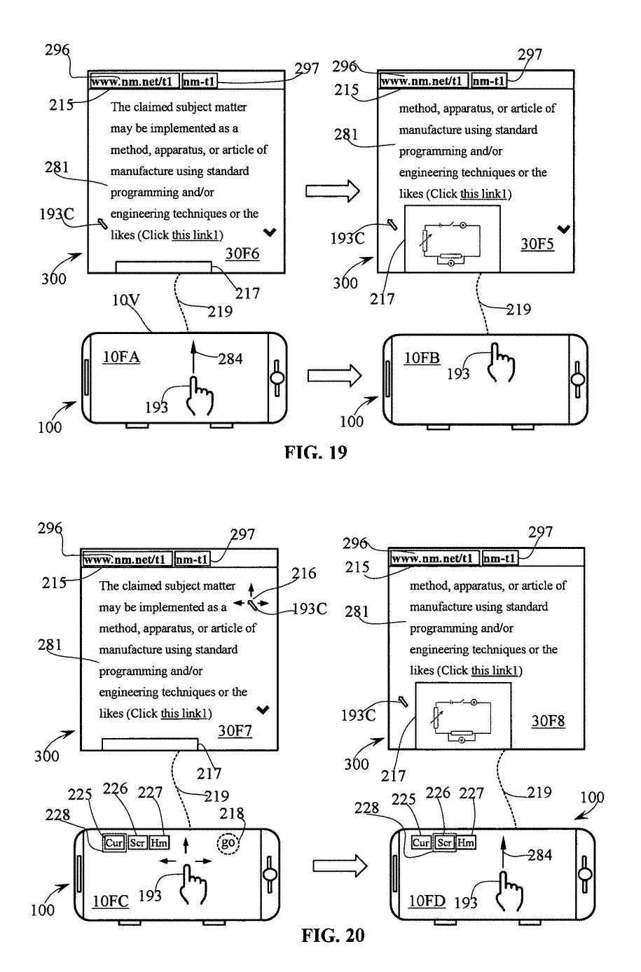

Reference is now made to FIG. 19, which includes two display views, 30F6 and 30F5 of the secondary display device 300, which are associated, respectively, with two display views 10FA and 10FB of the mobile computing device 100. For both the two display views 30F6 and 30F5, the App being executed by the mobile computing device 100 is also the web browser 215 showing the same web page 218 and having the same tab 297. The web page 218 has a web address 296 that is shown with the browser address box 215. The display view 30F6 is the same as the display view 30F1 of FIG. 18A. The lower portion of the exemplary web page 281 is a photo image 217. As shown in FIG. 19, on the display view 30F6, most part of this photo image 217 is hidden; and on the display view 30F5, most part of this photo image 217 is shown. So this changing from the display view 30F6 to display view 30F5 represents a conventional “scrolling” process. Thus the term “scrolling”, as used herein and in the annexed claims, shall means causing the display view of a display device to show different portion(s) of a display content of the same App or Application, or for to show different portion(s) of a display content of the operating system of the mobile computing device 100. In this example of FIG. 19, the scrolling is in vertical direction. In general, the scrolling may be in vertical or horizontal direction, or in any direction along or across the 2-D surface of the secondary display device 300.

In the example of FIG. 19, the vertical scrolling of the web page 281 displayed on the secondary display device 300 (from display views 30F6 to 30F5) is realized by conducting the aforementioned front-touch hand gesture input along the arrow 284 on the touchscreen 10FA of the mobile computing device 100, according to some embodiment of the present invention, which is also indicated by the change of position of the user hand 193 from display view 10FA to display view 10FB of the mobile computing device 100.

Therefore, by consideration FIGS. 18 and 19 together, it can be readily seen that, when the aforementioned combination touchpad input (with input from the touch-sensitive lateral side 10V conducted by the hand 191) is used for cursor movement control, then the aforementioned front-touch hand gesture input (without input from the touch-sensitive lateral side 10V) can be used for scrolling. Alternatively, when the aforementioned front touchpad input (without input from the touch-sensitive lateral side 10V) is used for cursor movement control, then the aforementioned combination hand gesture input from the touchscreen 10FA of the mobile computing device 100 (with input from the touch-sensitive lateral side 10V conducted by the hand 191) can be used for scrolling. Therefore, by making the lateral side 10V touch-sensitive, it is very easy for the user to switch between scrolling a display content and moving the position of the cursor 193C.

In fact employing the touch-sensitive lateral side 10V is not the only way for the user to switch between scrolling a display content and moving the position of the cursor 193C; Such switching may also be controlled by display buttons on the touchscreen display of the mobile computing device 100, according to some embodiment of the present invention, which is demonstrated by the example of FIG. 20. FIG. 20 also includes two display views, 30F7 and 30F8, of the secondary display device 300, which are the same, respectively, as the two display views 30F6 and 30F5, in FIG. 19. In FIG. 20, the related App (web browser 215), the display content (web page 281), and the related the reference numbers are also the same as those of FIG. 19.

In FIG. 20, the display views 30F7 and 30F8 of the secondary display device 300 are controlled by the user through, respectively, the touchscreen displays 10FC and 10FD of the mobile computing device 100. The difference between the examples of FIG. 20 and FIG. 19 is, in FIG. 20, the switching between the two functions of scrolling a display content and moving the position of the cursor 193C is controlled by display-control buttons 225 (“Cur” or “Cursor”), 226 (“Scr” or “scrolling”), and 227 (“Hm” or “Home”) on the touchscreen display of the mobile computing device 100.

As shown on the display view 10FC in FIG. 20, (i) when the user clicks and selects the display-control button 225 (“Cur”), a highlight box 228 will be moved to this button 225, indicating that the touchscreen 10FC of the mobile computing device 100 shall be used for controlling the movement of the cursor 193C on the display view 30F7 of the secondary display device 300 (as described above in connection with FIG. 18); (ii) when the user clicks on and selects the display-control button 226 (“Scr”), the highlight box 228 will be moved to this button 226, indicating that the touchscreen 10FD of the mobile computing device 100 shall be used for scrolling the display content on the display view 30F8 of the secondary display device 300; Such scrolling is indicated by the change of position of the photo image 217 (at the bottom of the web page 281) between the display view 30F7 and 30F8; and the front-touch hand gesture input on the touchscreen 10FD for such scrolling is indicated by the arrow 284.

Two-Screen Computer System

The foregoing disclosure in connection with FIGS. 18-20 pertains to providing a much larger secondary display device 300 (having no touch input function) for the mobile computing device 100, and how to use the front touchscreen and the touch-sensitive lateral side of the mobile computing device 100 to interact with the display contents on the secondary display device 300, including cursor-movement control, clicking on a display element such as a web link, scrolling, and typing on virtual keyboard. So the functions provided by the front touchscreen and the touch-sensitive lateral side of the mobile computing device 100 is equivalent to the functions of the physical keyboard and the touchpad of a conventional laptop computer. These functions of cursor-movement control, clicking on display elements, scrolling, and typing on virtual keyboard may also be used in a two-screen (or two-display) computer system according to some embodiment of the present invention.

Comparing with the examples of FIGS. 18-20, which only employs one of the two screens for displaying, in the two-screen computer system, both the two screens shall be used for displaying App or operating-system related display contents, and the user shall be allowed to interact with display elements on both two screens (instead of just one screen). In some embodiment, the sizes of the two screens in such two-screen computer system maybe similar to one another. Since one of the two screens (or display devices) is a touchscreen display, and can be used for providing the functions of cursor-movement control, clicking on display elements, scrolling, and typing on virtual keyboard, there is no need for a physical keyboard and a touch in such a two-screen computer system. So such a two-screen computer system of the present invention shall provide a user with much larger effective display area compared with any of the conventional laptop computer.

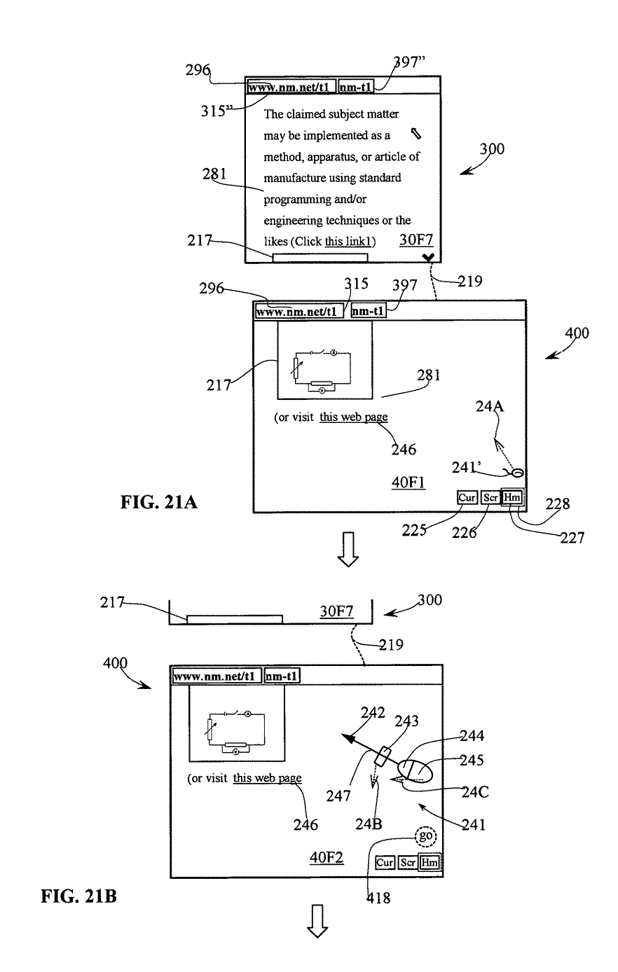

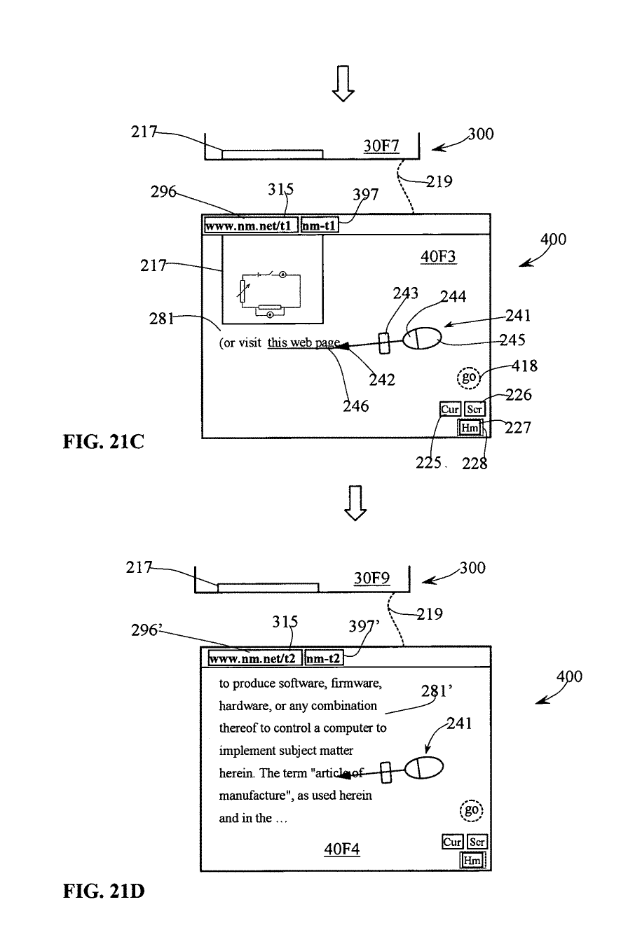

FIGS. 21A-21D illustrate exemplary methods for allowing the user to interact with display contents in such two-screen computer system. As shown therein, the two-screen computer system includes a primary device body 400 having a primary touchscreen display (shown as display views 40F1, 40F2, 40F3, and 40F4) and a secondary display device 300. It is understood that, the display view 30F7 of secondary display device 300 in the drawings is symbolic, for indicating that the primary device 400 is connected to a secondary display device 300 via a connection 219; And the difference in size between this two drawing elements 300 and 400 is not pertinent to the actual physical sizes of the devices. In fact the 2-D size of the secondary display device 300 may be the same as (or close to) the size of the front touchscreen display of the primary device 400. When the secondary display device 300 is not attached, the primary device 400 may also be used as a mobile-computing device (such as a tablet computer or the like).

As shown in FIG. 21A, the two devices 400 and 300 includes two display views 40F1 and 30F7 respectively. In this example, the two display views pertain to the same App, i.e., the web browser having a web address box 315/315″ and a browser tab 397/397″, and also pertain to the same display content, which is the web page 281 having a web address 296 in the web address box 315/315″. The bottom portion of the web page 281 include a photo image 217. So it is readily seen from FIG. 21A that, (i) the display view 30F7 is the top portion of the web page 281, (ii) the display view 40F1 is the bottom of the same web page 281, which includes the photo image 217, and (ii) the top edge of the photo image 217 is included in the bottom part of the display view 30F7. It is understood that in FIGS. 21B-21D, only the lower portion of the display views (30F7 and 30F9) of the display device 300 is shown.

In the two-screen computer system 300-400, the user input for interaction with the display view 30F7 of the secondary display device 300, using the touchscreen and touch-sensitive lateral side of the primary device 400, including cursor-movement control, clicking on display elements, scrolling, and typing on virtual keyboard, etc., may be made the same as the examples of FIGS. 18-20 set forth above. It is, again, assumed that the secondary display device 300 is a simple displaying device without any touch-input function, so that it can be made much thinner and lighter. Therefore, only one touchscreen input device shall be used for user interaction with display views on two display devices. Accordingly, a “Hm” (or “Home”) display-control button 227 is provided on the touchscreen display (e.g., display view 40F1 in FIG. 21A) of the primary device 400 in addition to the display-control buttons 225 (“Cur” or “Cursor”), 226 (“Scr” or “scrolling”) of the FIG. 20 example. Similar to the example of FIG. 20, (i) when the user clicks on and selects the display-control button 225 (“Cur”), the touchscreen 40F1 (FIG. 21A) of the primary device 400 shall be used for controlling the movement of the cursor on the display view 30F7 secondary display device 300; and (ii)when the user clicks on and selects the display-control button 226 (“Scr”), the touchscreen of the primary device 400 shall be used for scrolling display content on the secondary display device 300. Same as example of FIG. 20, the highlight box 228 will be located at the respective clicked or selected display-control button.

Additionally, (iii) when the user clicks on and selects the display-control button 227 (“Hm”), the highlight box 228 will be moved to this button 227, as is shown on the display view 40F1 of the primary device 400, indicating that the touchscreen 40F1 (FIG. 21A) and the touch-sensitive lateral side of the primary device 400 shall be used for user input for interacting with the display content on the display 40F1 of the primary device 400 (instead of interacting with the display content on the secondary display device 300).

Also in this example of display view 40F1 of the primary device 400 (FIG. 21A), the home button 228 and the other two display-control buttons 225 (“Cur”) and 226 (“Scr”) are arranged in a single row (which is the same as that of FIG. 20), which shall indicate that the display view 30F7 of the secondary display device 300 and the display view 40F1 of the primary device 400 shall be “connected”. When the two display views 30F7 and 40F1 of the two devices are “connected” (as such term may be used herein and in the annexed claims), it means the two display views on the two display devices are attached together (as if they belongs to a single display device) (e.g., in response to scrolling input), regardless of which of the two display devices is currently being controlled by the touchscreen 40F1 and the touch-sensitive lateral side of the primary device 400.

For example, when the two display views 30F7 and 40F1 of FIG. 21A are connected, (i) the top (or left) half of a single display content 281 may be shown on the display view 30F7, and the bottom (or right) half of the single display content 281 may be shown on the display view 40F1; (ii) when touchscreen 40F1 of the primary device 400 receives horizontal (or vertical) scrolling input, the display content shown on the two display devices 400 and 300 shall move or scroll together as if the two display views are attached to one another; and (iii) when the user clicks on the web link 246 to a new web page, the display view 30F7 of the secondary display device 300 will show the top portion of the associated new web page, and the display view 40F1 of the primary device 400 will show the bottom portion of the associated new web page.

In the example of display views 40F3 and 40F4 of the primary device 400 (in FIGS. 21C and 21D), the home button 228 has been moved to a position below the other two display-control buttons 225 (“Cur”) and 226 (“Scr”), which shall indicate that the display views 30F7/30F9 of the secondary display device 300 and the display views 40F3/40F4 of the primary device 400 shall be “disconnected”. When the two display views 30F7 and 40F3 (FIG. 21C) of the two devices are “disconnected” (as such term may be used herein and in the annexed claims), it means the two display views of the two display devices may not related to one another. For example, when in such disconnected state, and when the user scrolls the display content on the display 40F3 of the primary device 400, or click on a link 246 or button thereon, the display view 30F7 of the secondary display device 300 shall remain unchanged.

It is understood that, with respect to the two-display or two-screen system set forth above, the control of switching between the connected and disconnected states of the two display devices is not limited to the example of FIG. 21. For example, there may be more display-control buttons, and the display-control buttons 225, 226, and 227 may be arranged in many different ways. There may also be many ways of highlighting any of these display-control buttons. Moreover, any graphical indicators that can be interpreted as connected-disconnected states can be used; and display of texts or the like may also be used for the same purposing of indicating whether the two display views 30F7 and 40F3 of the two devices are connected or disconnected. It is appreciated that, by providing the connected and disconnected states, the two-screen computer system of this aspect of the present invention can be equivalent to a conventional laptop computer with a screen display size twice as large.

Virtual Mouse

The exemplary display views in FIGS. 21A-21D are also provided for demonstrating a concept of virtual mouse according to another aspect of the present invention. The function of the virtual mouse 241 is to simulate that of a physical mouse of a conventional desktop computer. A propose of providing the virtual mouse 241 is also for allowing the user of a mobile computing device (such as a tablet computer) to do more complex tasks such as working on productivity software applications mentioned above. In the drawing, reference number 241 is for representing a full-size virtual mouse on the display of the primary device 400; and reference number 241′ is for representing a reduced-size or minimized virtual mouse. When the user does not need to use the virtual mouse 241, she can just push it to a predefined position (such as the lower-right corner), where the size of the virtual mouse 241′ will be substantially reduced, as is shown on the display view 40F1 in FIG. 21A. When the user does need to use the virtual mouse 241′, she/he can just “pull” it out of the corner, and the virtual mouse 241′ will return to its full size as 241, as is shown on the display views 40F2, 40F3, and 40F4 in FIGS. 21B-21D respectively.

The virtual mouse 241 includes a tip 242, a rotation handle 243, a motion-control body 245, a click portion 244, and a shaft 247 for ‘attaching’ all parts of the virtual mouse together, as is indicated on the display view 40F2 in FIG. 21B. The user can move the virtual mouse 241 around on or across the display view 40F2 of the display device 400 by pushing the motion-control body 245. The user can also use the rotation handle 243 to rotate and change the direction of arrow of the tip 242, in which case the center of the motion-control body 245 will not change, and other parts of the virtual mouse 241 shall rotate around the center of the motion-control body 245. Alternatively, the rotation handle 243 may also be used to “stretch” the virtual mouse 241, i.e., changing the distance between the motion-control body 245 and the rotation handle 243. In this way, the virtual mouse can be made smaller or larger, as desired by the user. It is preferred that, the rotation handle 243 cannot be used to change to position of the motion-control body 245.

The tip 242 of the virtual mouse 241 is for simulating the function of a cursor on a display of a conventional desktop computer, i.e., for locating the position of a display element that the user wants to interact with; and the function of the click portion 244 is for letting the user click on it when the desired display element that the user wants to interact with is located by the tip 242. For example, if the user wants to click on the web link 246, she/he may first move the tip 242 of the virtual mouse 241 to the web link 246, then the user may click on the click portion 244 on the touchscreen 40F3 (FIG. 21C). Alternatively, the click button 244 may be located at other positions on the display 40F3. For example, the “go” button 418 may be used for such function of clicking in replacement of the click portion 244 of the virtual mouse 241 (e.g., when the tip 242 of the virtual mouse 241 has been moved to the web link position 246, the use may click on the “go” button 418 for activating the link 246).

In the figures, (I) the change from display view 40F1 of FIG. 21A to the display view 40F2 of FIG. 21B is in response to the user dragging the minimized virtual mouse 241′ out of the corner, as indicated by the arrow 24A, and hence the virtual mouse becoming a full-sized virtual mouse 241; (II) the change from display view 40F2 of FIG. 21B to the display view 40F3 of FIG. 21C is (in addition to change in relative positions of the display-control buttons 225, 226, and 227 described above) in response to the user first rotating the virtual mouse 241, using the rotation handle 243, as indicated by the arrow 24B, and then moving the motion-control body 245 of the virtual mouse 241 to the left, as indicated by the arrow 24C, whereby the web link 246 on the display is located by the tip 242 of the virtual mouse 241; (III) the change from display view 40F3 of FIG. 21C to the display view 40F4 of FIG. 21D is when the user either clicks on the “go” button 418 on the display view 40F3 or clicks on the click portion 244 of the virtual mouse 241; and consequently, the web page 281′, which has a web address 296′ and to which the web link 246 on the display view 40F3 is linked, is displayed on the display view 40F4 of the primary device 400.

As mentioned above, in the FIGS. 20C and 20D example, the primary device 400 and the secondary display device 300 are “disconnected”, as indicated by the relative positions of the display-control buttons 225, 226, and 227, thus the display view 30F9 of the secondary display device 300 of FIG. 21D shall remain the same as the display view 30F7 of FIG. 21C while the display view of the primary device 400 changes from 40F3 (the web page 281) to 40F4 (web page 281′) in response to user clicking the web link 246.

Calendar Based Social Network

This aspect of the present invention pertains to Social Network Service(s) (or “SNS”). As it is well known in the art, a SNS provides its users with a platform for sharing information, such as sharing photos, videos, status updates, and expressions of opinions, etc., for interacting with one another over the Internet, and for building social networks or social relations among people who share similar interests, activities, backgrounds or real-life connections. Examples of such SNS includes Facebook, twitter, LinkedIn, Instagram, and Pinterest, etc. A user of a SNS may allow a specific category of his or her information to be shared among a particular social circle or group. For example, a user may want her recent vacation photo pictures to be available to the public, and her wedding pictures to be shared only among her best friends, etc. Usually a SNS will allow a user to create a public profile and a list of users with whom to share connections and information. One drawback of the prior art is, the prior art SNS does not facilitate users sharing calendar information.

It can be readily seen that, calendar sharing among close friends, family members, and co-workers could be as important as sharing any other information on a SNS. For examples, (i) a SNS user may need to know when or if her best friend or a family member is available when planning an event (such as planning a vacation); and it would be inconvenient for the user to contact her best friend or family member every time she is planning a similar event; and (ii) at a workplace, a manager may want to know, through a SNS, which part-time employees are available for covering a late night shift, and it would be inconvenient for the manager to try to contact each and every part-time employee whenever he is making weekly work schedule for the employees, etc. According to this aspect of the present invention, in addition to facilitating sharing of conventional social network information among a social circle of a user (such as a photo, video, discussion, chat, status updates, etc.), a SNS may also allow the user to edit and update her/his calendar, and to make her/his calendar information to be partially or entirely shared among different social circles or social groups of the user.

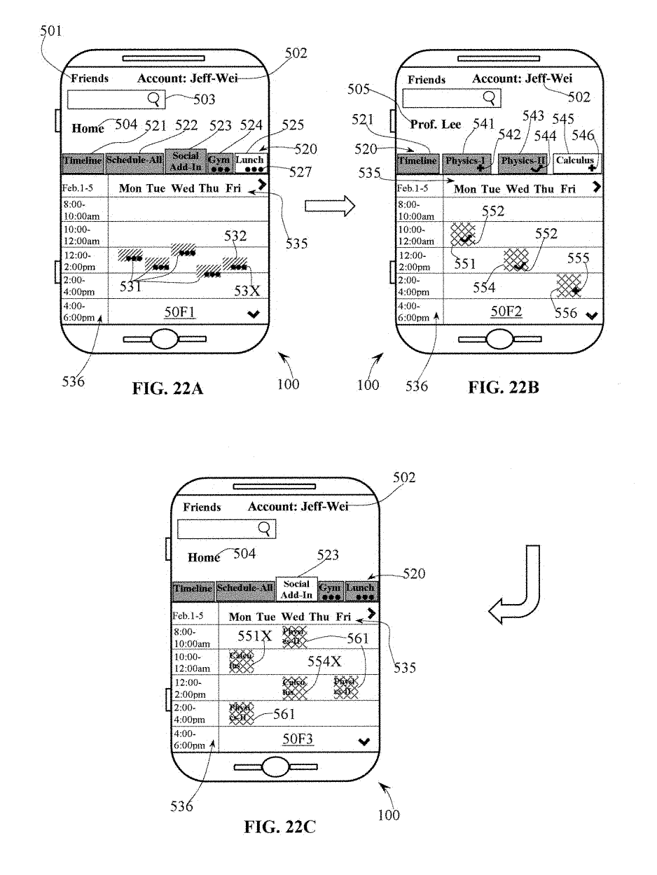

In FIGS. 22A-24C, the display views 50F1, 50F2, 50F3, 50F4, 50F5, 50F6, 50F7 and 50F8 of the mobile computing device 100 are exemplary mobile device user interfaces of a calendar based SNS according to this aspect of the present invention. As shown in the FIG. 22A example, the top portion of the SNS user interface display view 50F1 includes: (i) a user's account username 502 (“Jeff-Wei”); whenever the user is logged into her user account, her account name will be so displayed; (ii) a “Friends” button 501, which is provided for allowing the user 502 to cause the mobile device 100 to display lists of names or account names of the user's various social circles, groups, or friends; Similar to the conventional SNS, the user may setup, create, and define levels of interaction different social circles/groups, and add different usernames (such as usernames of her friends) to any of these social circles/groups; a (iii) a search box 503 for allowing the user 502 to search for her friends; and (iv) a display-view indication button 504 for indicating that current user interface display view 50F1 pertains to the user's own calendar and timeline information; In FIGS. 22B-24C, this display-view indication button may show that the current display view pertains to information of a friend or co-worker of the current user or user account.

In FIGS. 22A-24C, the positions of the user account name 502, Friends button 501, search box 503, and the display-view indication button 504 are substantially the same. As shown, the display views 50F1, 50F2, and 50F3 in FIGS. 22A-22C, respectively, pertains to the same user (“Jeff-Wei”), as indicated by the same user account name 502.

Each of the SNS user interface display view in FIGS. 22A-24C further includes a tab section 520. In FIG. 22A, the tab section 520 comprises five tabs 521, 522, 523, 524, and 525. The display function of these tabs is similar to that of a conventional web browser. The display content associated with a tab will be displayed below the tab section 520 when such tab is clicked or selected by the users. In the example of user interface display view 50F1 of FIG. 22A, the 5^{th} tab 525 has been clicked on or selected by the user, and hence the display content (which is the user's lunch schedule) displayed below are associated with this tab 525.

The display views in FIGS. 22A-24B pertain to calendar information of either the current user (or current user account) or a friend of the current user. As shown in each of these display views, the calendar section is below the tab section 520, and includes (i) a times-of-the-day column 536, which is for indicating the time period of each scheduled event within a day, and (ii) a day-of-the-week row 535, which is for indicating the date or day of each scheduled event; and these are a typical arrangement of a weekly calendar. And as usual, each of these calendars includes a plurality of scheduled events. In the example of display view 50F1 of FIG. 22A, the reference number 531 is used for generally representing these scheduled events, which also include the scheduled event 532. As shown therein, the box for indicating the scheduled event 532 includes a social setting button 53X, which is for allowing the user 502 to select which one of his/her social groups or which friends are allowed to view this schedule event 532. Similarly, a social setting button 527 is provided within the tab 525 for allowing the user 502 to select which one of his/her social groups or which friends are allowed to view all the schedule events under this category 525 (i.e., “lunch schedule”).

In FIG. 22A, within the tab section 520, the first tab 521 is “Timeline”. The functionality of this Timeline tab is similar to the function of the timeline page on the user interface display of a conventional SNS (such as Facebook.com, Twitter.com, etc.): i.e., allowing the user to post up typical social network timeline messages, such as photos, videos, discussions, comments, chats, status updates, etc., that the user may want to share with his or her friends, so that the user may interact with other users in a manner similar to or the same as using a conventional SNS. In the example of FIG. 22B, the display-view indication button 505 indicates that the display contents below the tab section 520 pertains to a friend of the user 502 (instead of the user himself or herself), and thus the timeline tab 521 in FIG. 22B pertains to the social network timeline messages posted by this friend 505 (“Prof. Lee”) of the user 502. By clicking on and selecting this tab 521, the user 502 will be able to view such timeline messages of this friend 505 (“Prof. Lee”). As used herein and in the annexed claims, the term “friend” means generally a member of any of the user's social groups or social circles, or one of the user's family members.

In FIG. 22A, similar to the tab 525, the tab 522, 523, 524 within the tab section 520 all pertain to different components of the calendar information of the user 502. The reason the user may want to divide her calendar into more than one components is, the user may want different components of her calendar to be shared among different social circles or groups. For examples, the user may want (i) her workout (or gym) schedule 524 to be completely private (without sharing it with any other people), and (ii) her lunch schedule 525 to be shared with her co-workers so that, for example, her co-workers can know when she is not available for answering client phone calls.

In the example of FIG. 22A, the tab 523 (“Social Add-in”) is for allowing the user 502 to view any of his or her friends' scheduled events (or calendar information) that have been previously selected by the user (see below); this is a case where the user wants to include or add or incorporate his/her friend's scheduled events (or calendar information) into the user's own calendar so that the user does not need to search for and display the calendar of this friend frequently. The tab 522 (“Schedule-All”) is for allowing the user to view all the scheduled events, including all the scheduled events added into the tabs 523, 524, and 525 and all the scheduled events added directly into the tab 522.

The change from the exemplary display view 50F1 of FIG. 22A to the exemplary display view 50F2 of FIG. 22B is for representing a situation where the user 502 has selected to view the timeline and calendar information of one of his/her friend (“Prof. Lee”) that are available to the user, as indicated by the display-view indication button 505. As shown therein, the tab section 520 on the display view 50F2 includes four tabs: tab 521 (“timeline”), tab 541 (“Physics-I”), tab 543 (“Physics-II”), and tab 545 (“Calculus”). In this example, it is assumed that the user's friend 505 (“Prof. Lee”) is a college professor, and the user 502 is a student of the professor. And the user wants to add the class schedules to be taught by the college professor 505 (“Prof. Lee”) for the semester into his/her own calendar.

In FIG. 22B, within the tab 541 (“Physics-I”), an add button 542 is provided for allowing the user to add all the scheduled events (i.e., class schedules) under this tab 541 into her/his own calendar, so that after this add button 542 is clicked or selected, whenever the user clicks or selects the tab 522 (“Schedule-All”) or tab 523 (“Social Add-In”) of the user's own calendar (see FIG. 22A), the user will be able to view these scheduled events (i.e., class schedules) under this tab 541. Similarly, add buttons are provided for the tabs 543 and 545. The add button (unchecked) 546 is included in the tab 545. In case of the tab 543, the user 502 had previously clicked or selected the associated add button 544, such that the add button 544 has changed from a “plus” sign to a “checked” sign, as is shown in the drawing.

In the example of FIG. 22B, the tab 545 (the “calculus” class) has been clicked on and selected by the user 502, and thus the calendar or scheduled events 551, 554, and 556 displayed on the display view 50F2 pertains to this tab 545. Similar to the add button 542 described above, these scheduled events 551, 554, and 556 are also provided with add buttons, including two checked add buttons 552 and an unchecked add button 555 respectively. In this example, the user 502 has selected the two add buttons 552, and thus they have changed from “plus” signs to “checked” signs. And the user 502 has decided to not select the add button 555. Accordingly, the scheduled events 551, 554, will be included in the user's own calendar; and the scheduled event 556 will not be included in the user's own calendar.

The change from the exemplary display view 50F2 of FIG. 22B to the exemplary display view 50F3 of FIG. 22C is for representing a situation after the user has checked the add buttons 544 and 552 in FIG. 22B, and has switched back to the user's own calendar, as indicated by the display-view indication button 504. And thus the scheduled events posted by the friend 505 (“Prof. Lee”) that has been so checked by the user on the display view 50F2 of FIG. 22B will be shown under the tab 523 (“Social Add-In”) on the display view 50F3 of FIG. 22C, which pertains to the user 502's own calendar. In particular, the scheduled events 551 and 554 on display view 50F2 of FIG. 22B are shown as 551X and 554X on the display view 50F3 of FIG. 22C, indicating that the user 502 (“Jeff-Wei”) has added the two scheduled events of her friend 505 (“Prof. Lee”) into her own calendar 504. Similarly, the all the scheduled events included in the tab 543 (“Physics II”) on display view 50F2 of FIG. 22B are shown as scheduled event 561 on the display view 50F3 of FIG. 22C.

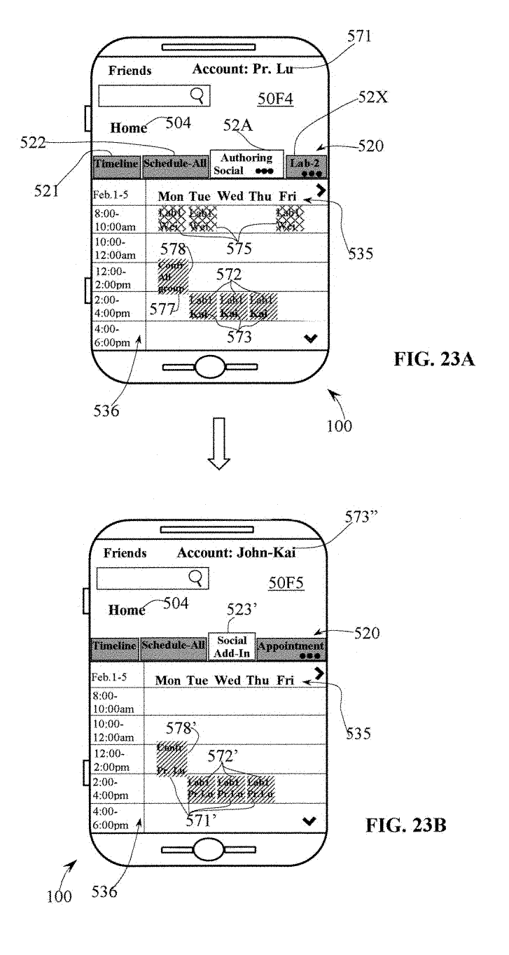

FIGS. 23A and 23B are for demonstrating the concept of social calendar authoring according to some embodiment of the present invention. Social calendar authoring means a first user 573″ (“John-Kai”, in FIG. 23B) has authorized a second user 571 (“Pr. Lu”, in FIG. 23A), who is one of his social friends, to add scheduled event into the first user's calendar. This is particular useful in a working environment where a higher-level management or supervisor requires his or her subordinate to attend a certain event. In the example of FIG. 23A, the second user 571 (“Pr. Lu”) is a college professor, and has used the Calendar based social network application to require his students to attend several scheduled events, including: (i) the three scheduled events 575 for a student to attend, (ii) the three scheduled events 572 (“Lab1”) for the student 573 (“Kai”, the first user) to attend, and (iii) a scheduled event 578 (“Conference”) for a group of students to attend, including the first user 573 (“Kai”). These scheduled events are shown on the display view 50F4 of FIG. 23A, which is a display content under the account of the second user 571 (“Pr. Lu”). Within the display areas of the scheduled events 578 and 572 on display view 50F4, the targets of these scheduled events are shown as 577 and 573 respectively.

FIG. 23B is a display content under the account of the first user 573/573″, for showing a result of the social calendar authoring by the second user 571 (“Pr. Lu”) in FIG. 23A and related to the first user 573/573″. As shown therein, on the display view 50F5, within the Social Add-In tab 523′ on the calendar of the first user 573/573″ (“John-Kai”), (i) the scheduled event 578 in FIG. 23A, which was created by the second user 571 (“Pr. Lu”), is automatically shown as scheduled event 578′, and (ii) the three scheduled events 572 in FIG. 23A, which was also created by the second user 571 (“Pr. Lu”), are automatically shown as scheduled event 572′. Within the display areas of these scheduled events on display view 50F5, the author or creator of these scheduled events are shown as 571′.

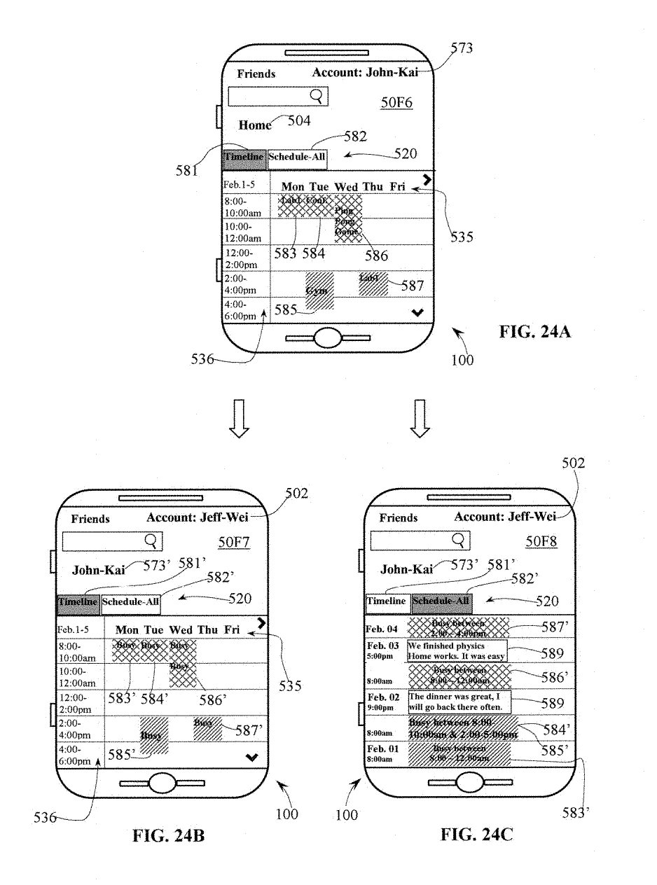

The example in FIGS. 24A-24C is for demonstrating different ways for a first user 573 (“John-Kai”, FIG. 24A) to allow his social friend 502 (“Jeff-Wei”, FIGS. 24B and 24C), the third user, to view his calendar events. As shown on display view 50F6 in FIG. 24A, within the calendar tab 582 (“Schedule-All”) under the account of the first user 573, there are five scheduled events 583, 584, 585, 586, and 587. Since this is the first user 573's calendar, and is under his own account, as indicated by the “home” indicator 504, specific information about these five scheduled events, such as brief names of these events, are shown on this display view 50F6 of FIG. 24A.

But in this examples of FIGS. 24A-24C, the first user 573 has decided to only allow his social friend 502 to know that he is not available during these time periods of the scheduled events 583, 584, 585, 586, and 587, and to not allow his friend 502 to view any detailed information about these five calendar events. Accordingly, as shown on the display views 50F7 and 50F8, in FIGS. 24B and 24C, respectively, the only information related to these calendar events are “busy”.

As shown, the display views 50F7 and 50F8, in FIGS. 24B and 24C, respectively, are under the user account of the third user 502, whereas the display indicator 573′ indicates that, the display views 50F7 and 50F8 are for displaying the calendar events (under the tabs 582′ and 581′, respectively) of another user, i.e., the social friend, or the first user 573 (“John-Kai”). Accordingly, in FIG. 24B, the five calendar events 583′, 584′, 585′, 586′, and 587′ correspond, respectively, to the calendar events 583, 584, 585, 586, and 587 on the display view 50F6 in FIG. 24A. As shown in FIG. 24B, within each of the marked areas of these five calendar events 583′, 584′, 585′, 586′, only the word “busy” is shown, indicating that the first user 573 only wants to inform the third user 502 that he is not available during these five time period without telling the third user exactly what he plans to do during the time periods of these five calendar events.

In FIG. 24B, the display content below the tab section 520 is under the tab 582′ (“Schedule-All”), which corresponds to the tab 582 in FIG. 24A, and which is for showing all the calendar events of the first user 573 that have been made available by the first user 573 to the third user 502. In FIG. 24C, the display content below the tab section 520 is under the tab 581′ (“Timeline”), which corresponds to the tab 581 in FIG. 24A, and which is for showing all the timeline messages or information of the first user 573 that have been made available by the first user 573 to the third user 502.

As shown in FIG. 24C, the first user 573 has made each of his calendar events 583, 584, 585, 586, and 587 (FIG. 24A) as a timeline events, and has made such calendar events on timeline available to the third user 502. Accordingly, the timeline events 583′, 584′, 585′, 586′, and 587′ in FIG. 24B correspond to the calendar events 583, 584, 585, 586, and 587 in FIG. 24A. In addition to these calendar events, the timeline 581′ in FIG. 24C also includes other timeline messages 589 that are posted and made available to the third user 502 by the first user 573.

What is claimed is:

1. A mobile computing device comprising:
a processor;
memory coupled to said processor and configured to maintain application program instructions that are executable on said processor to perform operations;
a front side having a front display coupled to said processor for displaying an avatar and a virtual environment, wherein said avatar is deemed one of a plurality of virtual objects and elements within said virtual environment, and is to be instructed to move relative to other virtual objects and elements within said virtual environment;
a back panel;
a plurality of user-input buttons installed on exterior side of said back panel and coupled to said processor;
a battery for providing power to all electronic components of the mobile computing device; and
lateral sides extending between said front side and said back panel;
wherein said processor, said memory, and said battery are enclosed within said front side, said back panel, and said lateral sides;
said operations comprising:
receiving a first user-input instruction from a first user-input button on said exterior side of said back panel;
in response to receiving said first user-input instruction, causing said avatar to move in a first direction within and relative to said other virtual objects and elements of said virtual environment.

2. The mobile computing device as set forth in claim 1, wherein said first user-input button is situated at the bottom of a relatively small concave area on said exterior side of said back panel.

3. The mobile computing device as set forth in claim 1, wherein each of said plurality of user-input buttons is received at the bottom of a relatively small concave area on said exterior side of said back panel.

4. The mobile computing device as set forth in claim 1, wherein said operations further comprises:
receiving a second user-input instruction from a second user-input button on said exterior side of said back panel; and
in response to receiving said second user-input instruction, causing said avatar to move in a second direction within said virtual environment.

5. The mobile computing device as set forth in claim 4, wherein said second user-input button is received at the bottom of a relatively small concave area on said exterior side of said back panel.

6. The mobile computing device as set forth in claim 4, wherein said operations further comprises:
receiving a third user-input instruction from a third user-input button on said exterior side of said back panel; and
in response to receiving said third user-input instruction, causing said avatar and virtual environment to rotate relative to one another.

7. The mobile computing device as set forth in claim 1, wherein said operations further comprises:
receiving a second user-input instruction from a second user-input button on said exterior side of said back panel; and
in response to receiving said second user-input instruction, causing said avatar and virtual environment to rotate relative to one another.

8. The mobile computing device as set forth in claim 1, wherein said operations further comprises:
receiving a null input instruction from said first user-input button; and
in response to receiving said null input instruction, causing said avatar to stop moving in said first direction within said virtual environment.

9. The mobile computing device as set forth in claim 8, wherein said avatar stops slowly.

10. The mobile computing device as set forth in claim 8, wherein said avatar stops immediately.

11. The mobile computing device as set forth in claim 1, wherein one of said lateral sides is touch sensitive for receiving user inputs and is a non-displaying lateral side.

12. A mobile computing device comprising:
a processor;
memory coupled to said processor and configured to maintain application program instructions that are executable on said processor to perform operations;
a front side having a front display coupled to said processor for displaying an avatar and a virtual environment, wherein said avatar is deemed one of a plurality of virtual objects and elements within said virtual environment, and is to be instructed to move relative to other virtual objects and elements within said virtual environment;
a back panel;
a plurality of user-input buttons installed on exterior side of said back panel and coupled to said processor;
a battery for providing power to all electronic components of the mobile computing device; and
lateral sides extending between said front side and said back panel;
wherein said processor, said memory, and said battery are enclosed within said front side, said back panel, and said lateral sides;
said operations comprising:
receiving a first user-input instruction from at least one of said plurality of user-input buttons;
in response to receiving said first user-input instruction, causing said avatar to perform an action within said virtual environment.

13. The mobile computing device as set forth in claim 12, wherein said action performed by said avatar is to rotate relative to said virtual environment.

14. The mobile computing device as set forth in claim 12, wherein said action performed by said avatar is to move in a first direction within and relative to said other virtual objects and elements of said virtual environment.

15. The mobile computing device as set forth in claim 12, wherein each of said at least one of said plurality of user-input buttons is situated at the bottom of a relatively small concave area on said exterior side of said back panel.

16. The mobile computing device as set forth in claim 12, wherein said operations further comprises:
receiving a second user-input instruction from a second user-input button on said exterior side of said back panel; and
in response to receiving said second user-input instruction, causing said avatar to move in a first direction within said virtual environment.

17. The mobile computing device as set forth in claim 12, wherein said first user-input instruction is a combination input instruction, and wherein said action performed by said avatar is a complex action.

18. A mobile computing device comprising:
a processor;
memory coupled to said processor and configured to maintain application program instructions that are executable on said processor to perform operations;
a front side having a front display coupled to said processor for displaying a first display view;
a back panel;
a battery for providing power to all electronic components of the mobile computing device; and
lateral sides extending between said front side and said back panel; wherein at least one of said lateral sides is touch sensitive for receiving user inputs and is a non-displaying lateral side;
wherein said processor, said memory, and said battery are enclosed within said front side, said back panel, and said lateral sides;
said operations comprising:
receiving a first user-input instruction from said at least one of said lateral sides;
in response to receiving said first user-input instruction, causing said front display to display a second display view.

19. The mobile computing device as set forth in claim 18, wherein said first display view and said second display view pertain to the same application program.

20. The mobile computing device as set forth in claim 18, wherein said first display view and said second display view pertain to two different application programs respectively.
